(19) United States
(12) Patent Application Publication
(10) Pub. No.: US 2015/0106705 A1
(43) Pub. Date: Apr. 16, 2015

(54) Adaptive Grammar Instruction - Verb Tense

(71) Applicant: Apollo Education Group, Inc., PHOENIX, AZ (US)

(72) Inventors: Annalies Vuong, Pittsburgh, PA (US); Alison Huettner, Pittsburgh, PA (US); Scott Fraundorf, Rochester, NY (US); Victoria Keiser, Seattle, WA (US)

(21) Appl. No.: 14/456,265

(22) Filed: Aug. 11, 2014

Related U.S. Application Data
(60) Provisional application No. 61/890,875, filed on Oct. 15, 2013.

(51) Int. Cl. G06F 17/24; G09B 7/00; G06F 17/28; G06F 3/0484; G06F 17/20; G06F 17/27

(52) U.S. Cl. CPC G06F 17/24; G06F 17/20; G06F 17/2795; G06F 17/28; G06F 3/0484; G09B 7/00
USPC 715/271

(57) ABSTRACT

A grammar teaching system provides adaptive practice to build students' grammar skills with respect to verb tense errors. The system displays a sentence to a user, and allows the user to identify the locations of verbs within the sentence and tenses of the identified verbs. The system reinforces correct designations of verbs using visual cues. If a user incorrectly identifies a term as a verb within a sentence, then the system displays information to help the user understand the nature of the incorrectly designated term. The system allows the user to determine whether the sentence includes a verb tense error and to select a particular verb in the sentence to replace in order to correct any verb tense error. The system allows the user to obtain help in correcting a verb tense error by providing optional tasks that step the user through the reasoning needed to correct the error.

### BENEFIT CLAIM AND CROSS-REFERENCE TO RELATED APPLICATIONS

This application claims the benefit of Provisional Appln. 61/890,875, filed Oct. 15, 2013, the entire contents of which is hereby incorporated by reference as if fully set forth herein, under 35 U.S.C. §119(e).

This application is also related to application Ser. No. 13/875,107, titled “Multi-Layered Cognitive Tutor”, filed May 1, 2013, and to application Ser. No. 14/053,519, titled “Adaptive Grammar Instruction”, filed Oct. 14, 2013, the entire contents of each of which is hereby incorporated by reference as if fully set forth herein.

### FIELD OF THE INVENTION

The present invention relates to teaching verb tense conventions in formal written language, and, more specifically, to an adaptive grammar teaching system configured to train users on identifying and correcting verb tense errors within natural language sentences.

### BACKGROUND

Natural languages are spoken languages (such as American English), which have grammar rules governing the composition of the natural language. There are stylistic conventions that apply to the written form of a natural language, which, unlike natural language per se, must be taught. When a person has not learned the proper stylistic conventions for a written language, the student may encounter difficulty in communicating in writing, particularly in formal registers. For example, it may be particularly difficult for a person who does not understand the stylistic rules of American English to write an error-free research paper or formal letter, which limits that person's ability to communicate effectively through writing.

Grammar checkers, e.g., Grammerly.com, Thelma Thistleblossom, and grammar checkers included with document editors such as Microsoft Word, identify certain types of grammatical errors in written documents. However, grammar error identification/correction is not the same as teaching grammar rules or proper stylistic conventions, even when the grammar checker indicates why each identified error is an error. Grammar checkers generally do not teach either prescriptive or descriptive rules of grammar, nor do grammar checkers target particular problems that users have with grammatical or stylistic rules. At times, grammar checkers identify “errors” that are not errors at all, and rely on the user's knowledge to ultimately determine whether an error exists. Thus, grammar checkers are generally ineffective at teaching a user the conventions of formal written language.

Some English courses, e.g., in secondary and higher education, attempt to teach prescriptive grammar rules, largely using face-to-face teaching techniques, quizzes, and other activities. At times, automation is used in such traditional English courses. However, this automation generally consists of providing a student with multiple-choice questions and giving the student feedback on the student's selected answers. It can be difficult for an English teacher to identify and aid each student with the student's individual grammar or stylistic misconceptions, especially since classes tend to be large and students tend to have a wide range of skill gaps with respect to mastery of prescriptive grammar rules. At least the above mentioned deficiencies can allow students to complete English courses without learning all of the prescriptive grammar rules that they need to produce error-free communications.

Therefore, it would be beneficial to provide an automated grammar teaching system that is configured to teach concepts of prescriptive stylistic conventions that are targeted to the needs of students.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example network arrangement for an automated grammar teaching system that adaptively instructs a user regarding grammar rules governing verb tense.

FIG. 2 depicts a flowchart for allowing a user to correct the tense of a selected verb in a displayed natural language sentence.

FIGS. 3A-3E depict a graphical user interface configured to allow a user to identify one or more verbs within a displayed natural language sentence.

FIGS. 4A-4E depict a graphical user interface configured to allow a user to correct a verb tense error in a displayed natural language sentence.

FIG. 5 depicts a flowchart for presenting a verb tense problem with multiple sentences to a user and allowing the user to correct one or more verb tense errors in the displayed sentences.

FIGS. 6A-6F depict a graphical user interface configured to allow a user to correct one or more verb tense errors in multiple displayed natural language sentences.

FIGS. 7A-7B depict a graphical user interface configured to allow a user to access help in correcting a verb tense error in a displayed natural language sentence via a set of optional tasks.

FIG. 8 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

An automated grammar teaching system delivers highly personalized, differentiated instruction to users. The automated grammar teaching system provides lessons and adaptive practice to build each student's skills for the rules of formal written English with respect to verb tense errors. Verb tense problems, configured to address each student's continuous learning needs with respect to granular grammar skills relating to identification and correction of verb tense errors, are automatically presented to students by the automated grammar teaching system.

According to an embodiment, the system displays a natural language sentence to a user, and allows the user to identify both the locations of verbs within the sentence and tenses of the identified verbs. The system reinforces correct designations of verbs and verb tenses using visual cues. In an embodiment, if a user incorrectly identifies one or more words as verbs within the displayed sentence, then the system displays remediation information to help the user understand the nature of the term that the user designated as a verb.

The system further allows the user to determine whether a displayed sentence includes a verb tense error and, if the sentence includes an error, to replace a particular verb in the sentence in order to correct the error. According to embodiments, the system also allows the user to select which verb in the displayed sentence to replace. The system further allows the user to obtain help in correcting a particular verb tense error by providing optional tasks that step the user through reasoning needed to correct the error.

### Adaptive Grammar Instruction Architecture

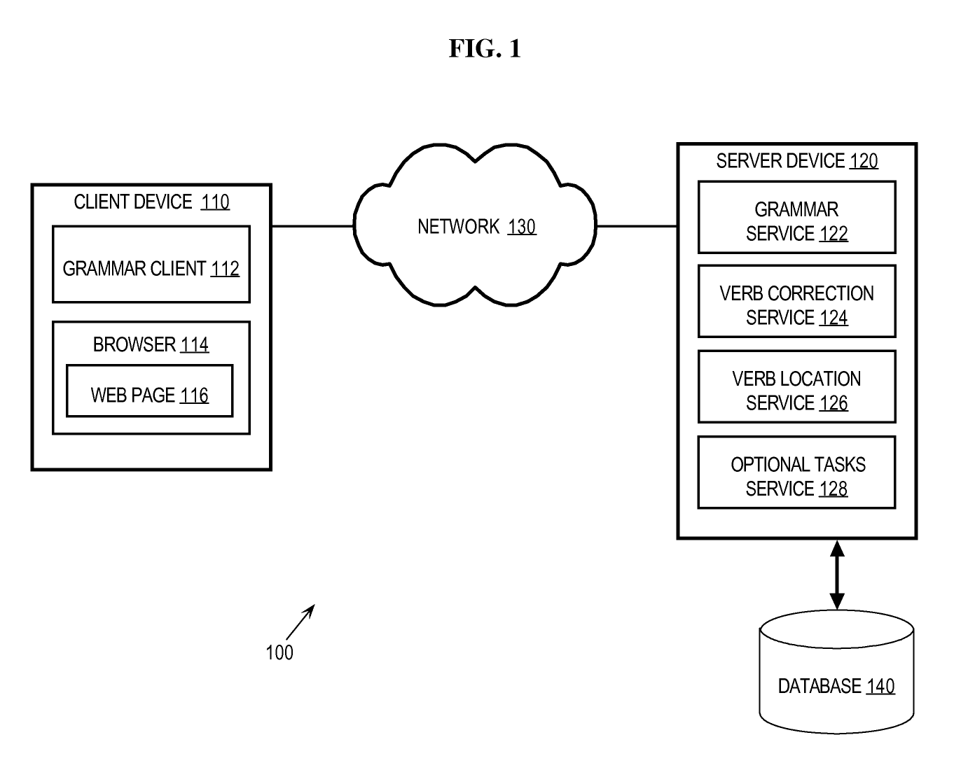

Techniques are described hereafter for adaptively instructing a user on grammar rules governing verb tense. FIG. 1 is a block diagram that depicts an example network arrangement 100 for an automated grammar teaching system that adaptively instructs a user regarding grammar rules governing verb tense, according to embodiments. Network arrangement 100 includes a client device 110 and a server device 120 communicatively coupled via a network 130. Server device 120 is also communicatively coupled to a database 140. Example network arrangement 100 may include other devices, including client devices, server devices, and display devices, according to embodiments. For example, one or more of the services attributed to server device 120 herein may run on other server devices that are communicatively coupled to network 130.

Client device 110 may be implemented by any type of computing device that is communicatively connected to network 130. Example implementations of client device 110 include, without limitation, workstations, personal computers, laptop computers, personal digital assistants (PDAs), tablet computers, cellular telephony devices such as smart phones, and any other type of computing device.

In network arrangement 100, client device 110 is configured with a grammar client 112 and a browser 114 that displays a web page 116. Grammar client 112 may be implemented in any number of ways, including as a plug-in to browser 114, as an application running in connection with web page 116, as a stand-alone application running on client device 110, etc. Grammar client 112 may be implemented by one or more logical modules, and is described in further detail below. Browser 114 is configured to interpret and display web pages that are received over network 130 (e.g., web page 116), such as Hyper Text Markup Language (HTML) pages, and eXtensible Markup Language (XML) pages, etc. Client device 110 may be configured with other mechanisms, processes and functionalities, depending upon a particular implementation.

Further, client device 110 is communicatively coupled to a display device (not shown in FIG. 1), for displaying graphical user interfaces, such as graphical user interfaces of web page 116. Such a display device may be implemented by any type of device capable of displaying a graphical user interface. Example implementations of a display device include a monitor, a screen, a touch screen, a projector, a light display, a display of a tablet computer, a display of a telephony device, a television, etc.

Network 130 may be implemented with any type of medium and/or mechanism that facilitates the exchange of information between client device 110 and server device 120. Furthermore, network 130 may facilitate use of any type of communications protocol, and may be secured or unsecured, depending upon the requirements of a particular embodiment.

Server device 120 may be implemented by any type of computing device that is capable of communicating with client device 110 over network 130. In network arrangement 100, server device 120 is configured with a grammar service 122, a verb correction service 124, a verb location service 126, and an optional tasks service 128. One or more of services 122-128 may be part of a cloud computing service. Functionality attributed to one or more of services 122-128 may be performed by a different service/client, such as another of services 122-128 or grammar client 112, according to embodiments. Services 122-128 may be implemented by one or more logical modules, and are described in further detail below. Server device 120 may be configured with other mechanisms, processes and functionalities, depending upon a particular implementation.

Server device 120 is communicatively coupled to database 140. Database 140 may reside in any type of storage, including volatile and non-volatile storage (e.g., random access memory (RAM), one or more hard or floppy disks, main memory, etc.), and may be implemented by one or more logical databases. The storage on which database 140 resides may be external or internal to server device 120.

Any of grammar client 112 and services 122-128 may receive and respond to Application Programming Interface (API) calls, Simple Object Access Protocol (SOAP) messages, requests via HyperText Transfer Protocol (HTTP), HyperText Transfer Protocol Secure (HTTPS), Simple Mail Transfer Protocol (SMTP), or any other kind of communication, e.g., from one of the other services 122-128 or grammar client 112. Further, any of grammar client 112 and services 122-128 may send one or more such communications over network 130, e.g., to one of the other entities of the system.

In an embodiment, each of the processes described in connection with one or more of grammar client 112 and services 122-128 are performed automatically and may be implemented using one or more computer programs, other software elements, and/or digital logic in any of a general-purpose computer or a special-purpose computer, while performing data retrieval, transformation, and storage operations that involve interacting with and transforming the physical state of memory of the computer.

### Sentence Problems Stored at the Database

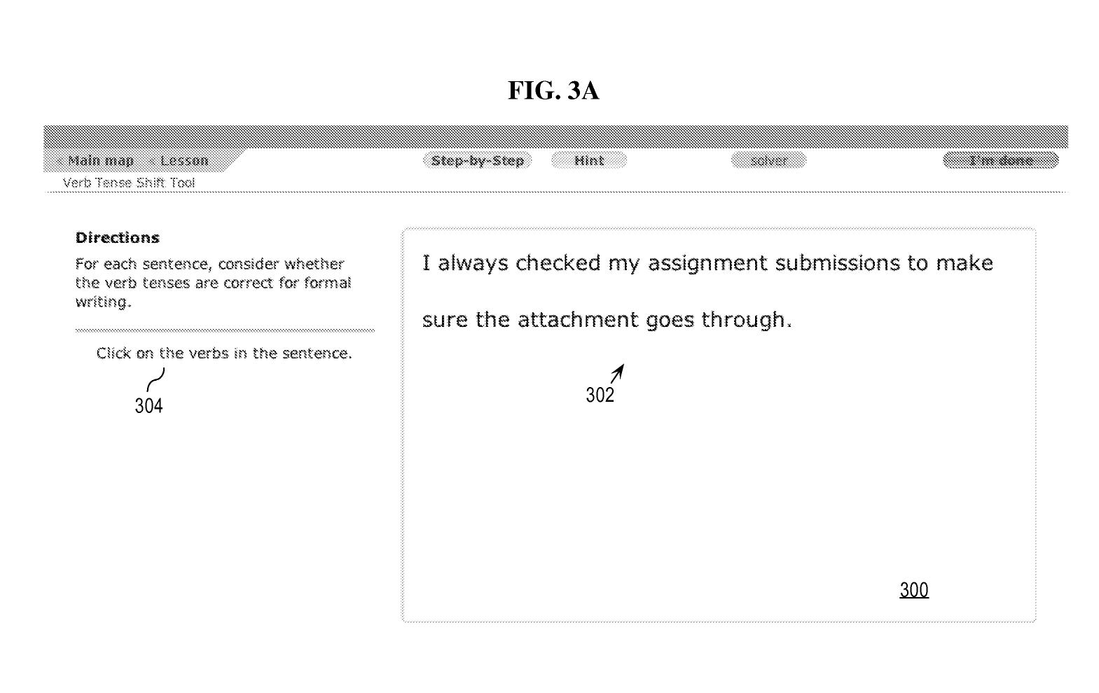

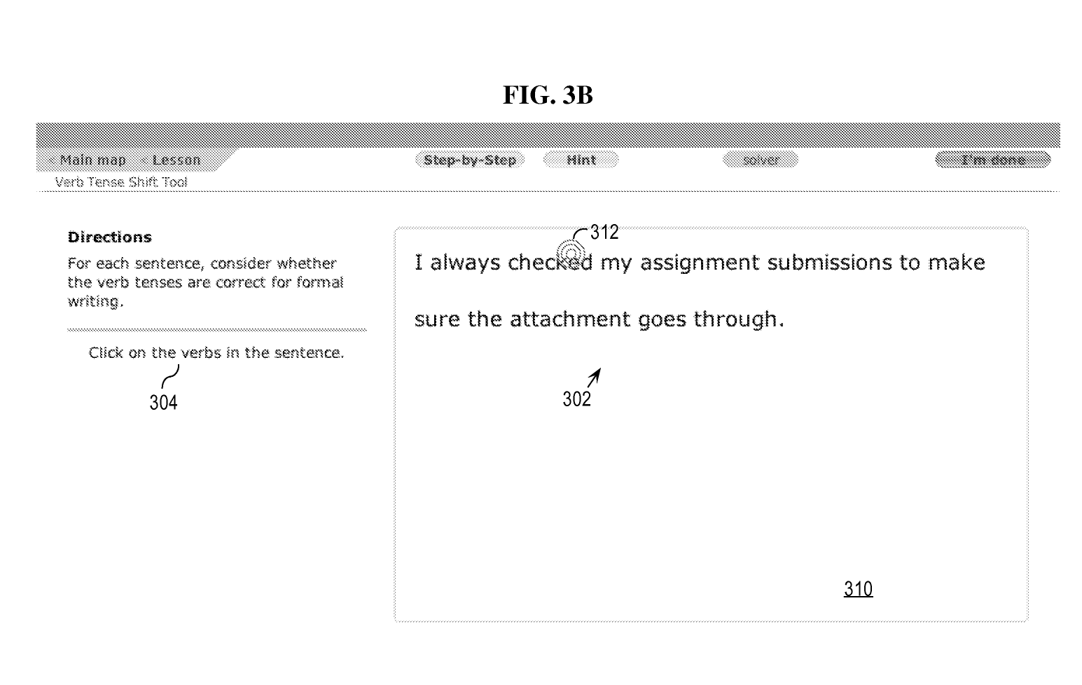

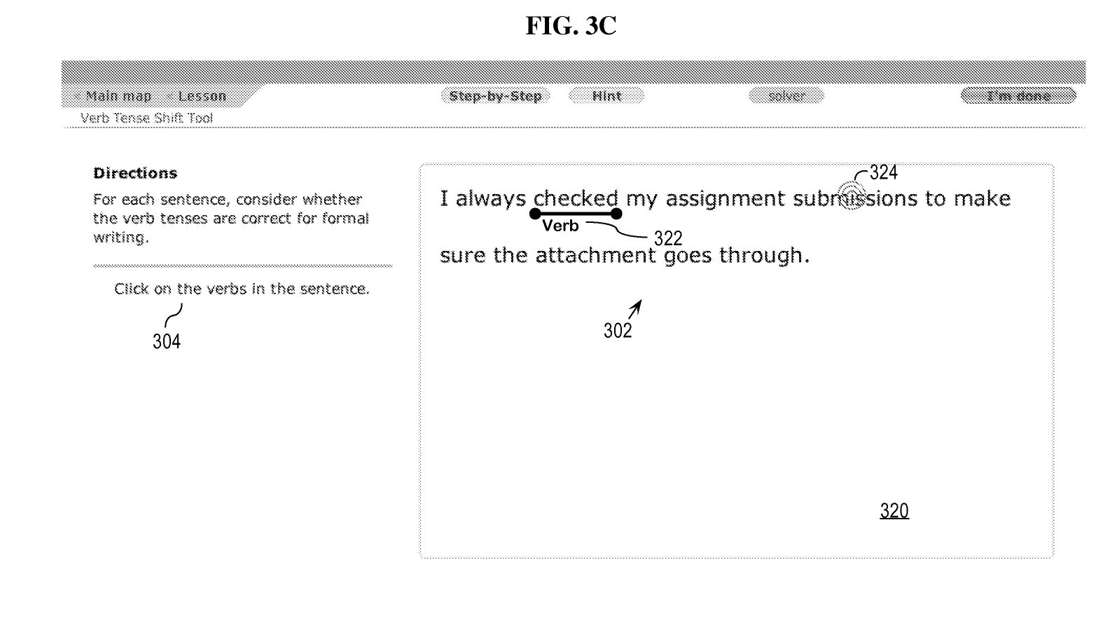

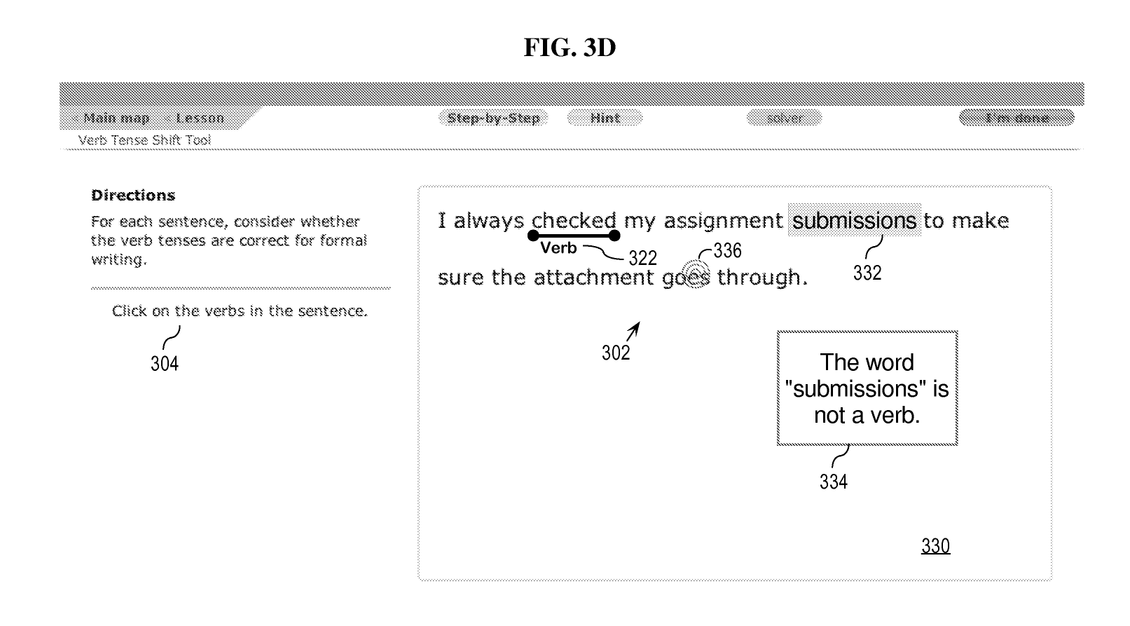

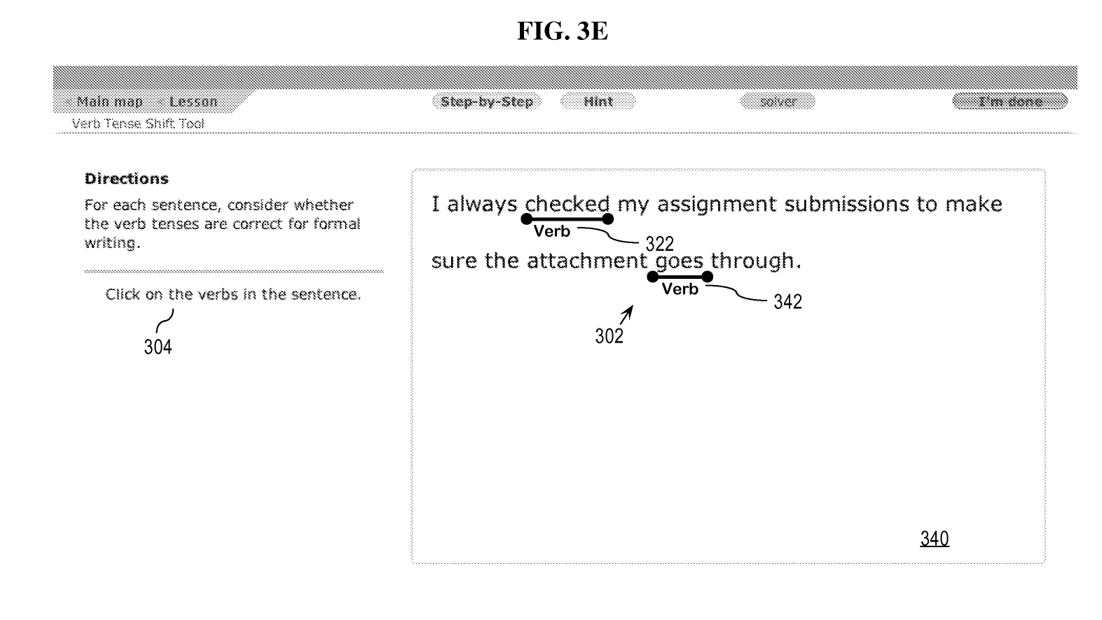

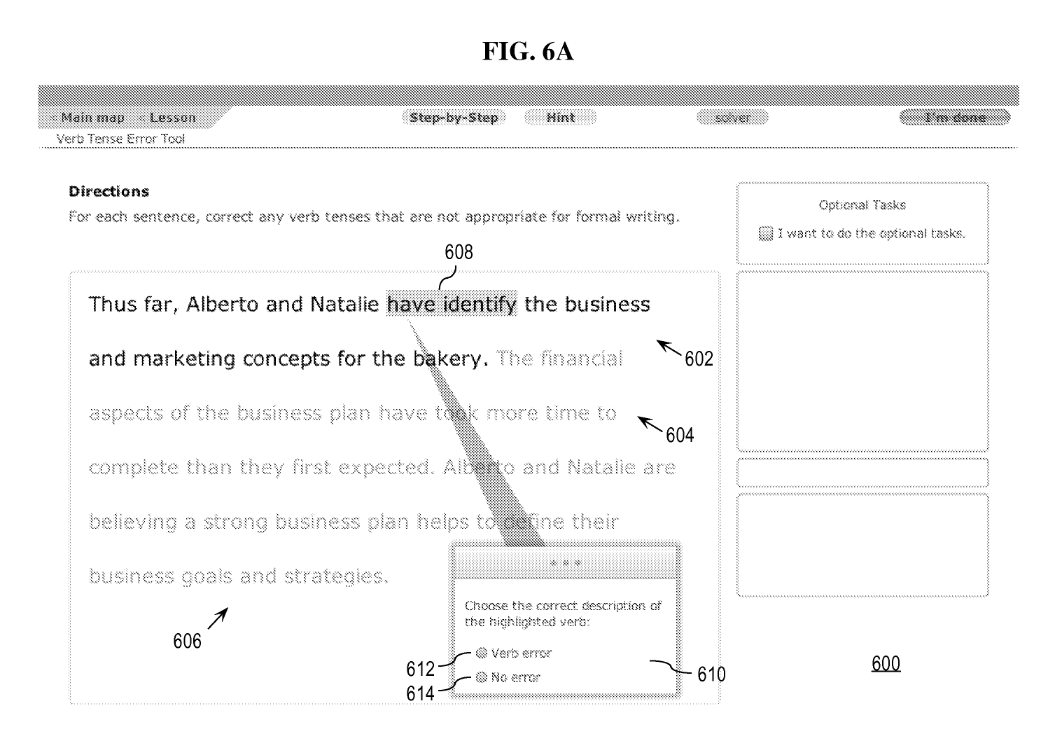

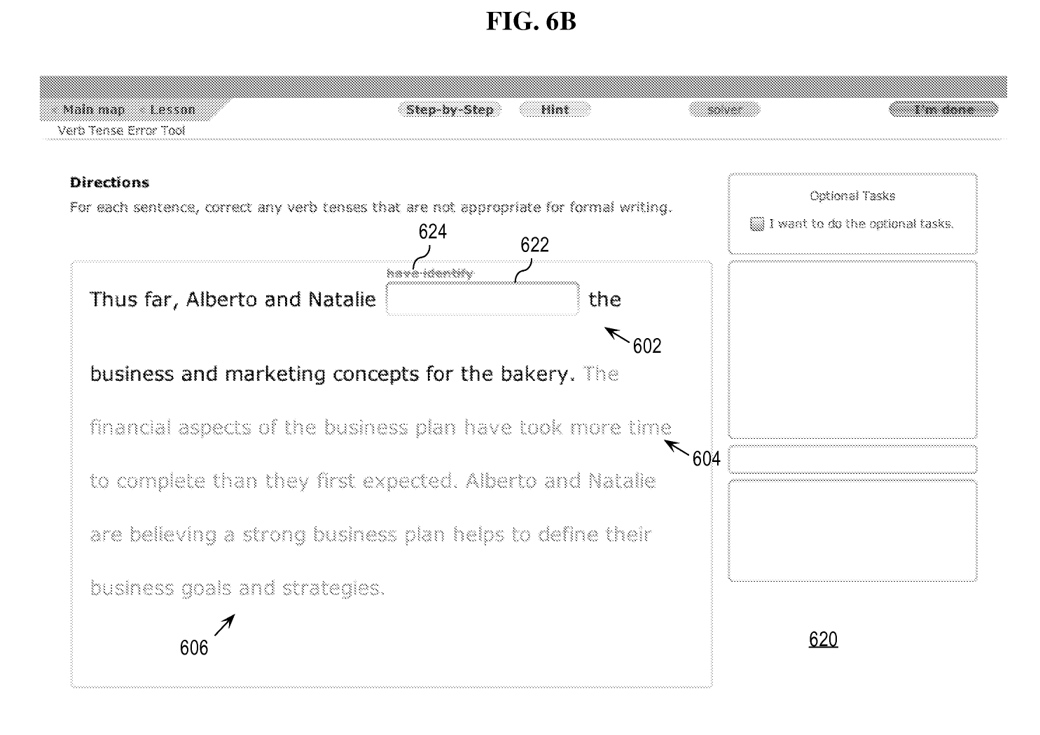

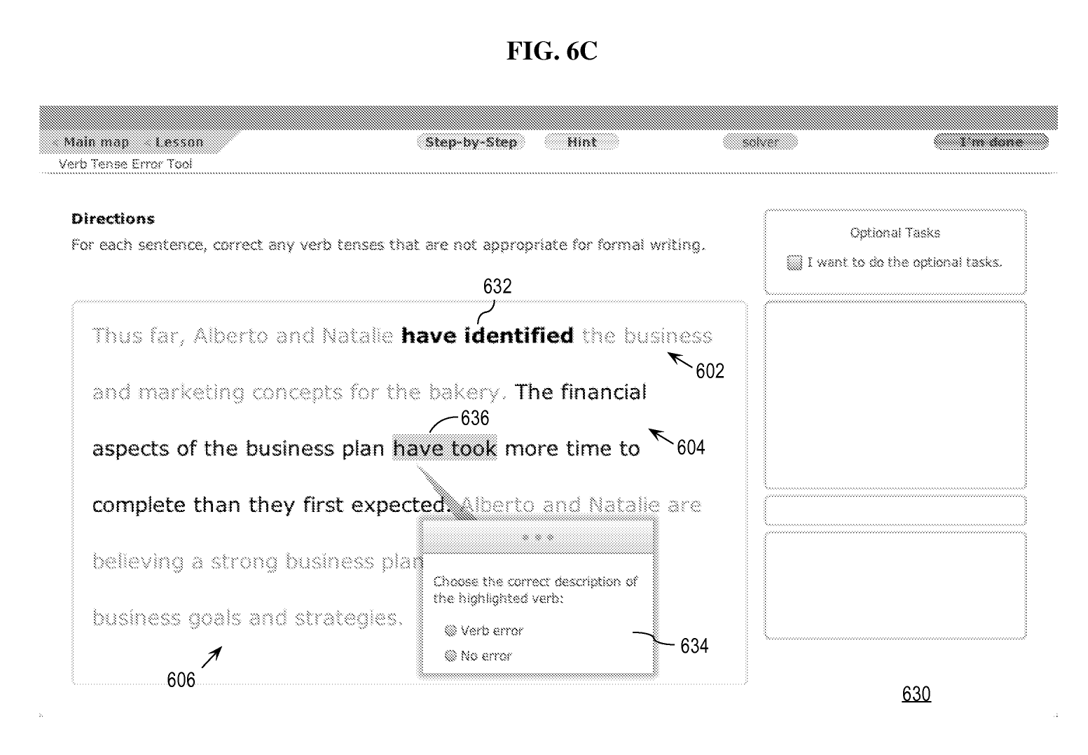

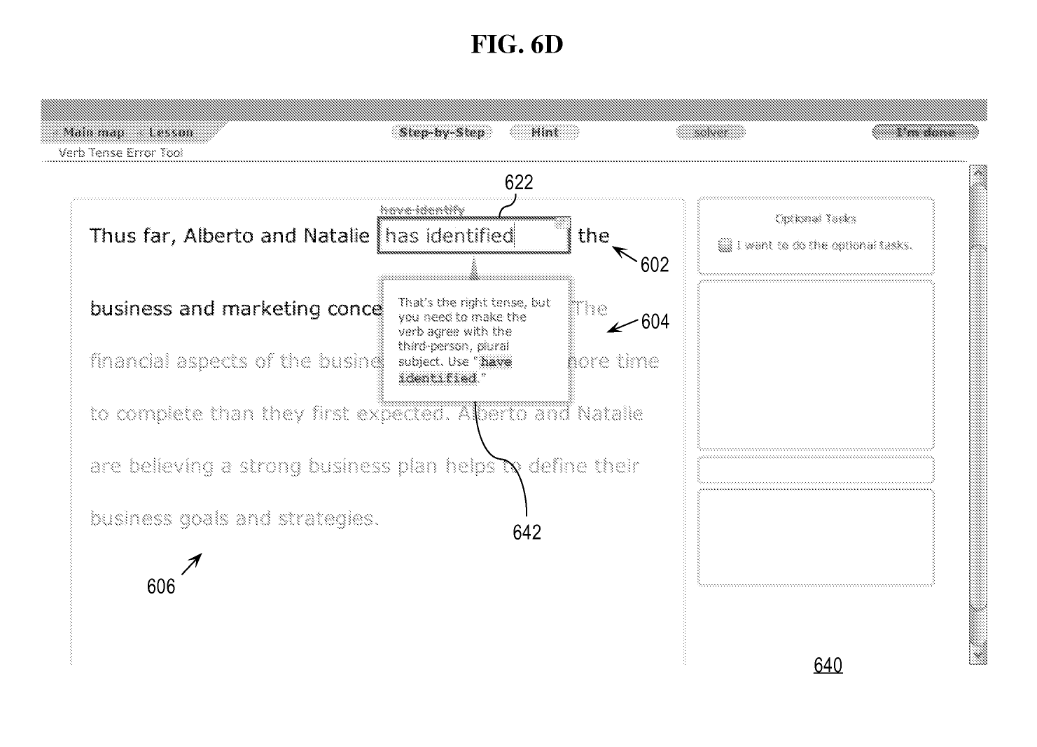

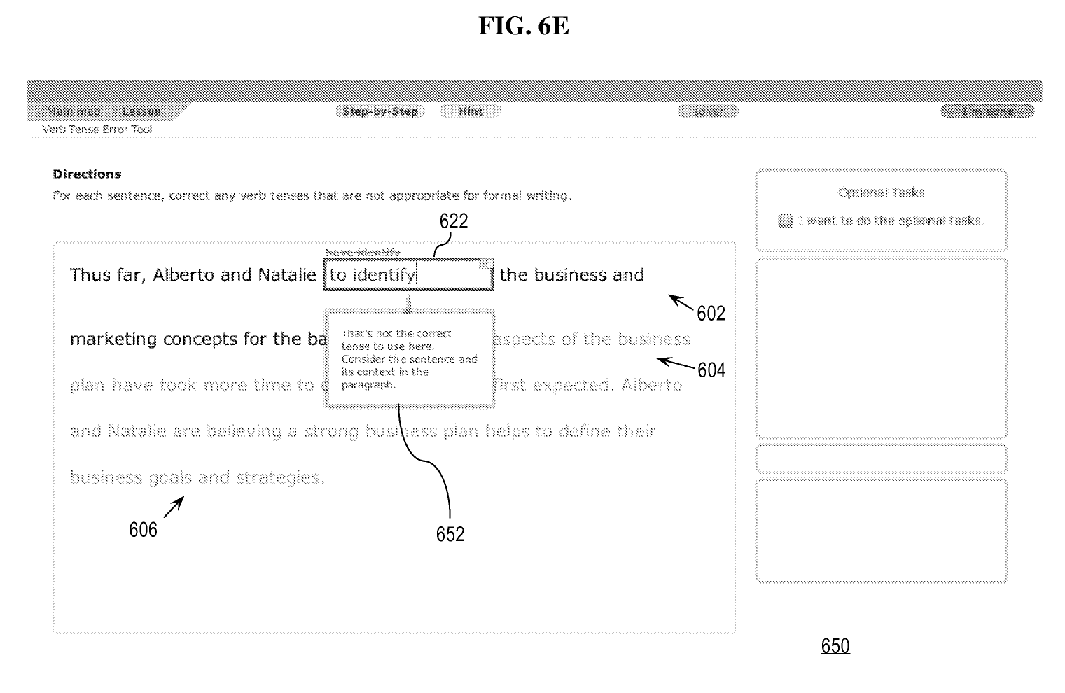

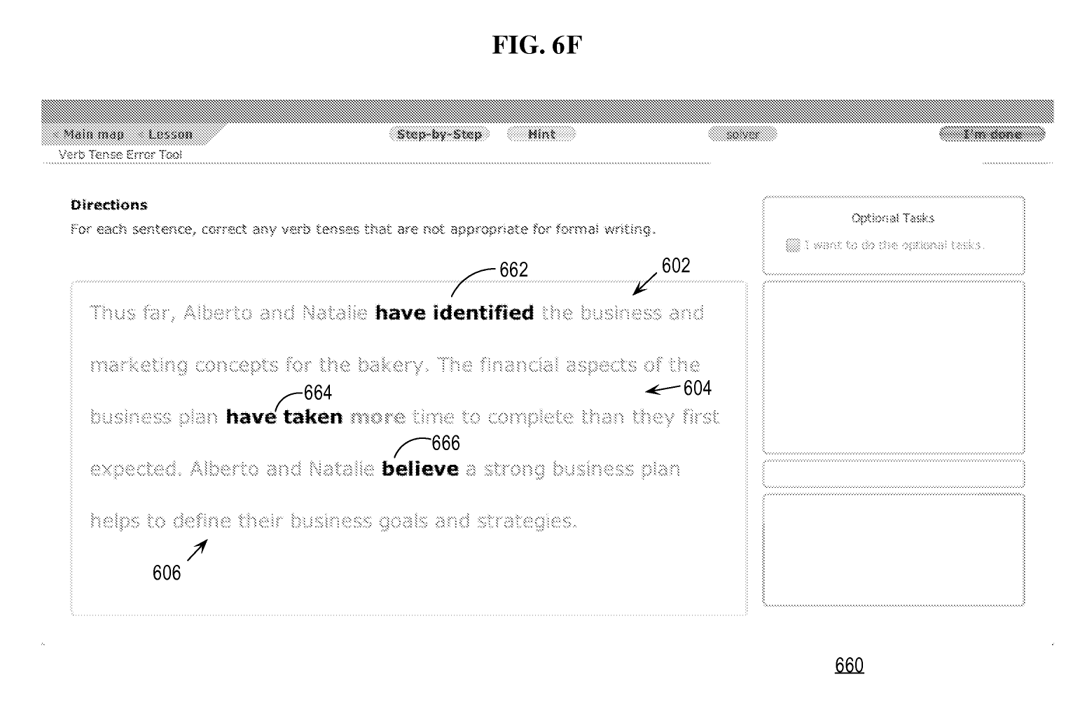

Database 140 stores a plurality of sets of problem data. In an embodiment, a set of problem data corresponds to a verb tense problem that may be displayed to a user, e.g., at graphical user interface (GUI) 300 of FIG. 3A, at GUI 600 of FIG. 6A, etc.

A particular verb tense problem includes at least one natural language sentence where one or more verbs in the natural language sentence are presented in an incorrect tense in the context of the natural language sentence. According to an embodiment, a verb (as the term is used herein) is a complete verb string comprising one or more natural language words that represent the verb. The following are example verb strings: “have walked”, “walks”, “is walking”, “walked”. Each of these verb strings includes one or more words that represent the verb communicated by the verb string. Herein, reference to a verb refers to the one or more words of the verb string for the verb. Furthermore, references herein to “words” and “sentences” refer to natural language words and natural language sentences, respectively.

A natural language sentence, i.e., of a particular verb tense problem stored at database 140, may also include one or more pseudoverbs. A pseudoverb is one or more words that may be confused with a verb, but that are not used as a verb within the context of the sentence in which the pseudoverb appears. For example, a particular verb tense problem includes the sentence: “He won the vote.” In this sentence, “won” is a verb and “vote” is a pseudoverb because the word “vote” may be used as a verb, but is not used as a verb (but as a noun) in the given sentence.

According to embodiments, a verb tense problem includes either (a) a single sentence (e.g., GUI 300), or (b) two or more sentences configured to be displayed together (e.g., GUI 600). A set of problem data also includes one or more of:
a list of one or more verbs within a sentence;
one or more locations of verbs within a sentence;
the tense of one or more verbs within a sentence;
tense forms of one or more verbs within a sentence (e.g., the past tense form, the present participle form, the past participle form, etc.);
a type of tense shift within a sentence (e.g., no shift, incorrect shift, correct shift);
one or more accurate corrections for one or more verbs within a sentence;
information that may be presented as hints;
information for optional tasks (as described in further detail below);
markup of a sentence (as described in further detail below);
one or more locations of pseudoverbs within a sentence;
remediation information for portions of a sentence (e.g., for display when a user identifies a pseudoverb as a verb); etc.

To illustrate a particular set of problem data, database 140 includes, in connection with the particular set of problem data, metadata embedded into the following marked-up sentence:

In [_pseudoverb]order[/_pseudoverb] to [_infinitiveVerb]pay[/_infinitiveVerb] my student [_pseudoverb]loans[/_pseudoverb] on [_pseudoverb]time[_pseudoverb], I [_verb]make[/_verb] a spreadsheet of my [_pseudoverb]expenses[/pseudoverb] each month, and I [_verb]use[/_verb] an online [_pseudoverb]banking[/_pseudoverb] [_pseudoverb]program[/_pseudoverb].

In connection with this marked-up sentence, database 140 also includes the following information for the identified verbs:

<ValueStructure container_type=“VERB”>

<Property name=“words” value=“make”/>
<Property name=“person” value=“_first”/>
<Property name=“number” value=“_singular”/>
<Property name=“plain-form” value=“make”/>
<Property name=“past-tense-generic” value=“made”/>
<Property name=“past-tense-ending” value=“_irregular”/>
<Property name=“past-participle” value=“made”/>
<Property name=“present-participle” value=“making”/>
<Property name=“present-tense-third-singular” value=“makes”/>
<Property name=“timeframe” value=“_present”/>
<Property name=“steady-state” value=“False”/>
<Property name=“published-article” value=“False”/>
<Property name=“possible-corrections”>

<Value>made</Value>

</Property>

</ValueStructure>
<ValueStructure container_type=“VERB”>

<Property name=“words” value=“use”/>
<Property name=“person” value=“_first”/>
<Property name=“number” value=“_singular”/>
<Property name=“plain-form” value=“use”/>
<Property name=“past-tense-generic” value=“used”/>
<Property name=“past-tense-ending” value=“_d”/>
<Property name=“past-participle” value=“used”/>
<Property name=“present-participle” value=“using”/>
<Property name=“present-tense-third-singular” value=“uses”/>
<Property name=“timeframe” value=“_present”/>
<Property name=“steady-state” value=“False”/>
<Property name=“published-article” value=“False”/>
<Property name=“possible-corrections”>

<Value>used</Value>

</Property>

</ValueStructure>

According to an embodiment, metadata for a sentence includes a tag that grammar service 122 uses for remediation information. Such remediation metadata identifies one or more words or phrases in a sentence that are not involved in a tense shift. For example, metadata in the marked-up sentence given above identifies the word “order” as a pseudoverb (i.e., “In [_pseudoverb] order[/_pseudoverb] to . . . ”). Grammar service 122 uses such metadata to identify particular remediation information to display to a user. For example, if a user identifies the pseudoverb “order” as a verb, then grammar service 122 uses the tag that marks that word to identify remediation text to display to the user in response to the user identifying the pseudoverb as a verb. Such remediation text may indicate as follows: “The word ‘order’ can be used as a verb, but is not used as a verb in this sentence.”

### Graphical User Interface Displaying a Verb Tense Problem

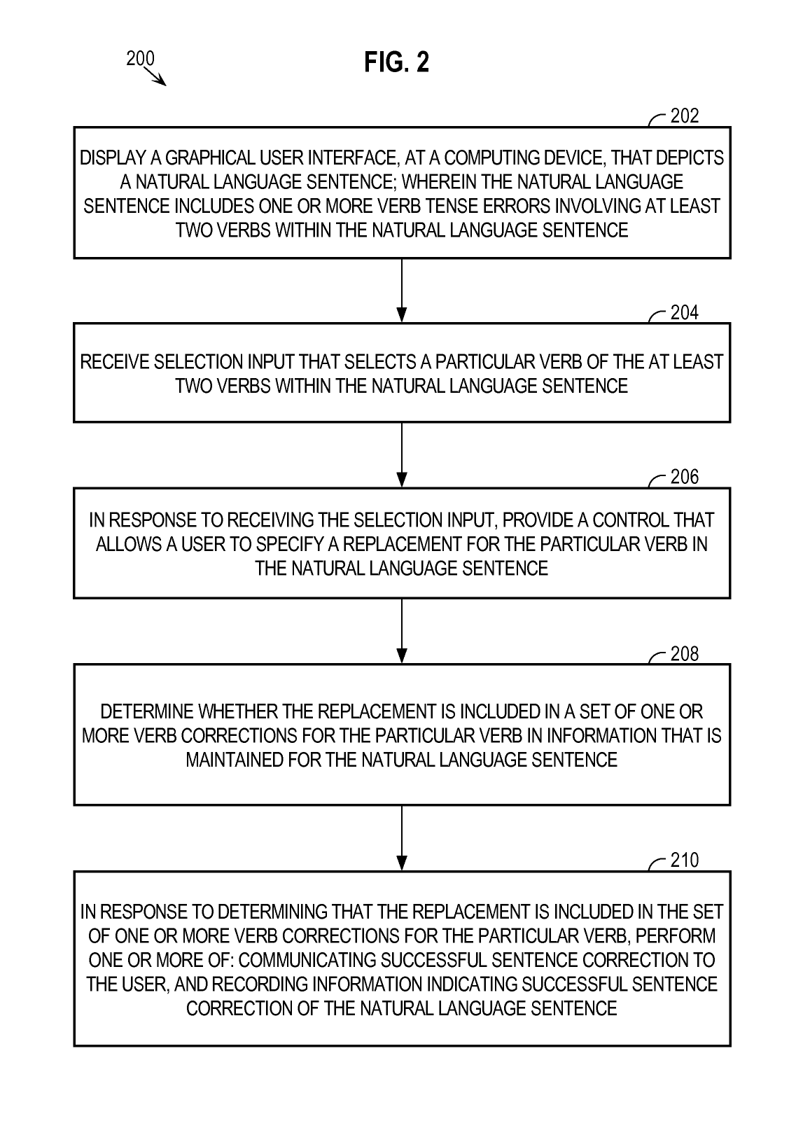

FIG. 2 depicts a flowchart 200 for allowing a user to correct the tense of a selected verb in a displayed natural language sentence. At step 202 of flowchart 200, a graphical user interface that depicts a natural language sentence is displayed at a computing device, wherein the natural language sentence includes one or more verb tense errors involving at least two verbs within the natural language sentence. For example, web page 116 (FIG. 1) includes a graphical user interface such as GUI 300 of FIG. 3A. According to an embodiment, GUI 300 is generated by grammar service 122 executing on server device 120 or by grammar client 112 executing on client device 110.

Grammar service 122 sends information for GUI 300 (such as information from database 140 for a particular verb tense problem to be displayed), via network 130, to grammar client 112. Grammar client 112 makes GUI 300 available to browser 114 executing on client device 110, and browser 114 displays GUI 300, i.e., as part of web page 116. According to another embodiment, grammar client 112 causes GUI 300 to be displayed outside of a browser, e.g., as part of a stand-alone application.

GUI 300 depicts a natural language sentence 302 that includes a verb tense error that is an incorrect tense shift involving the verbs “checked” and “goes”. A verb tense error that is an incorrect tense shift is a grammatical error in which two or more verbs within a sentence, the tenses of which should agree, have tenses that do not agree. Agreeing verb tenses are verb tenses that convey the same time frame. For example, “checked” is a past tense verb that conveys a past time frame. The tense of the verb “goes” should agree with the tense of “checked”, but instead is a present tense verb that conveys a present time frame (which is inconsistent with the past time frame of “checked”).

According to an embodiment, database 140 includes the following marked-up version of natural language sentence 302:

### Marked-Up Sentence I:

I always [_verb]checked[/_verb] my assignment submissions to [_infinitiveVerb]make[/_infinitiveVerb] sure the attachment [_verb]goes[/_verb] through.

### Identifying Verbs in a Displayed Sentence

According to an embodiment, grammar service 122 displays GUI 300 with instructions 304 that instruct the user to identify the verbs in sentence 302. Thus, through GUI 300, the grammar teaching system allows a user to practice verb identification in the context of pre-formulated natural language sentences. Verb identification is a fundamental granular grammar skill that a user needs in order to properly apply grammatical rules governing verb tense.

According to embodiments, a user identifies a particular word of sentence 302 as a verb, e.g., by clicking on a portion of GUI 300 that depicts the particular word, or by tapping (via a touch-sensitive display) on the portion of GUI 300 that depicts the particular word, or by moving a cursor to the portion of GUI 300 that depicts the particular word and identifying the word at the location of the cursor with a particular key stroke (such as ‘enter’, or ‘e’), etc. Verb location service 126 receives, through GUI 300, such verb identification input that identifies one or more words of displayed natural language sentence 302 as a verb.

To illustrate, GUI 310 of FIG. 3B depicts user identification of the word “checked” via input 312. Specifically, verb location service 126 receives input 312 that identifies the word “checked” in sentence 302. In response, verb location service 126 determines whether the identified word is a verb or is part of a verb string. Accordingly, verb location service 126 determines whether the word “checked” is identified as a verb within information for the displayed verb tense problem, which, according to an embodiment, includes Marked-up Sentence I above. Marked-up Sentence I identifies “checked” as a verb.

In response to determining that the word “checked” is a verb, verb location service 126 causes “checked” to be visually highlighted. An example of such a highlight is depicted in GUI 320 of FIG. 3C. Specifically, GUI 320 includes a visual highlight 322 that, according to the embodiment of GUI 320, underlines the word “checked” and labels the word with the label “Verb”. Such a visual highlight informs the user that they have correctly identified “checked” as a verb in sentence 302. Furthermore, the label reminds the user of exactly what the user has identified (i.e., the word “checked”, which is a “Verb”).

Once the user has received feedback on the previous word identification (i.e., of “checked”), the user has an opportunity to identify the remaining verb in sentence 302. As depicted at input 324 of GUI 320, the user identifies the word “submissions” as a verb. In response to receiving input 324, verb location service 126 determines whether the word “submissions” is identified as a verb within information for the displayed verb tense problem. Marked-up Sentence I has no special tagging on “submissions.” Therefore verb location service 126 determines that “submissions” is neither a verb nor a pseudoverb.

In response to determining that the word “submissions” is not a verb, verb location service 126 displays information about the word in the graphical user interface, such as is depicted in GUI 330 of FIG. 3D. Specifically, as illustrated in GUI 330, verb location service 126 visually highlights the identified word (“submissions”) with visual highlight 332 and provides information about the word “submissions” at information display 334. According to an embodiment, verb location service 126 retrieves the information for display 334 from remediation information for “submissions” in the verb tense problem information for the displayed problem.

According to embodiments, verb location service 126 displays more detailed information about the word “submissions” than is depicted in information display 334. For example, more detailed information about “submissions” may indicate that the term is similar to the verb “submit”, but is in a noun form.

As a further example, grammar service 122 displays the following sentence from a verb tense problem: “Many students want to improve their writing skills, so they practice the steps of the writing process.” In data for the problem, the word “writing” is labeled as a pseudoverb. In response to a user incorrectly designating the word “writing” in the example sentence as a verb, verb location service 126 displays information that is specific to the term “writing” as used in the sentence. Specifically, example help text reads “The word ‘writing’ is sometimes a verb, but it's not being used as one here.” In this example, verb location service 126 provides the user with information to help the user understand that certain words (i.e., pseudoverbs), such as “writing”, may be used as one of several parts of speech (noun, verb, etc.) depending on the context of the word within the sentence.

After providing feedback to the user for the user's identification of “submissions” as a verb, the user has another opportunity to identify the remaining verb in sentence 302. As shown in GUI 330, the user selects the word “goes” via input 336. Upon receiving input 336, verb location service 126 determines whether the word “goes” is identified as a verb within information for the displayed verb tense problem. Marked-up Sentence I identifies “goes” as a verb.

In response to determining that the word “goes” is a verb, verb location service 126 causes “goes” to be visually highlighted, such as is depicted in GUI 340 of FIG. 3E. Specifically, GUI 340 includes visual highlight 342 which, like visual highlight 322, underlines the word “goes” and labels the word with the label “Verb”. Since the user successfully identified the verb “goes” after successfully identifying the verb “checked”, both visual highlights 322 and 342 are displayed at GUI 340.

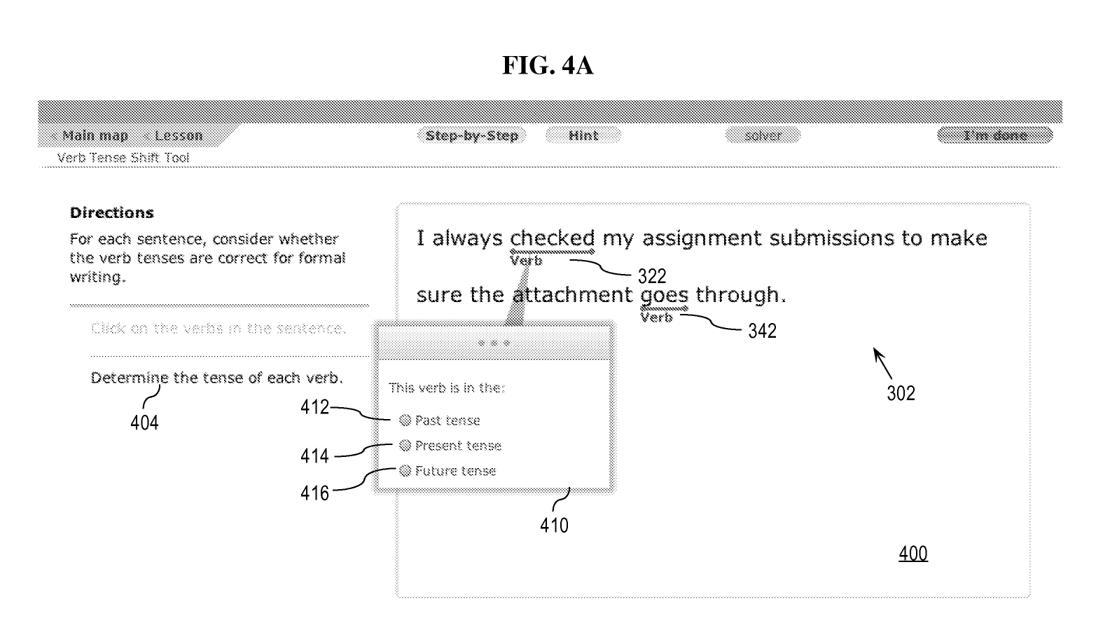

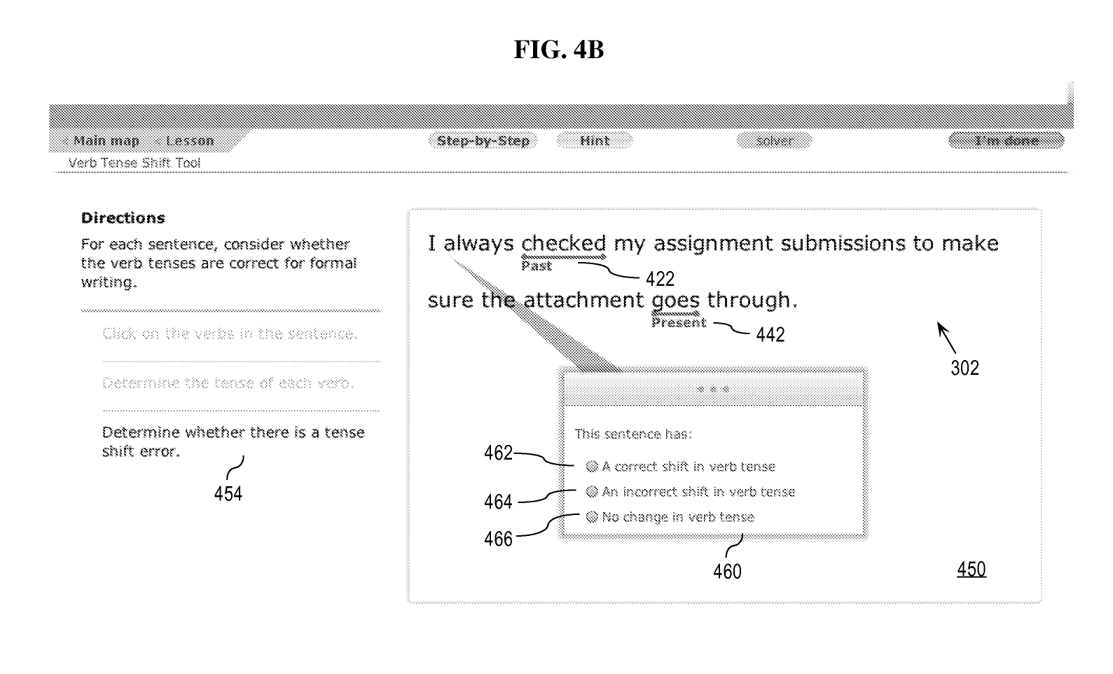

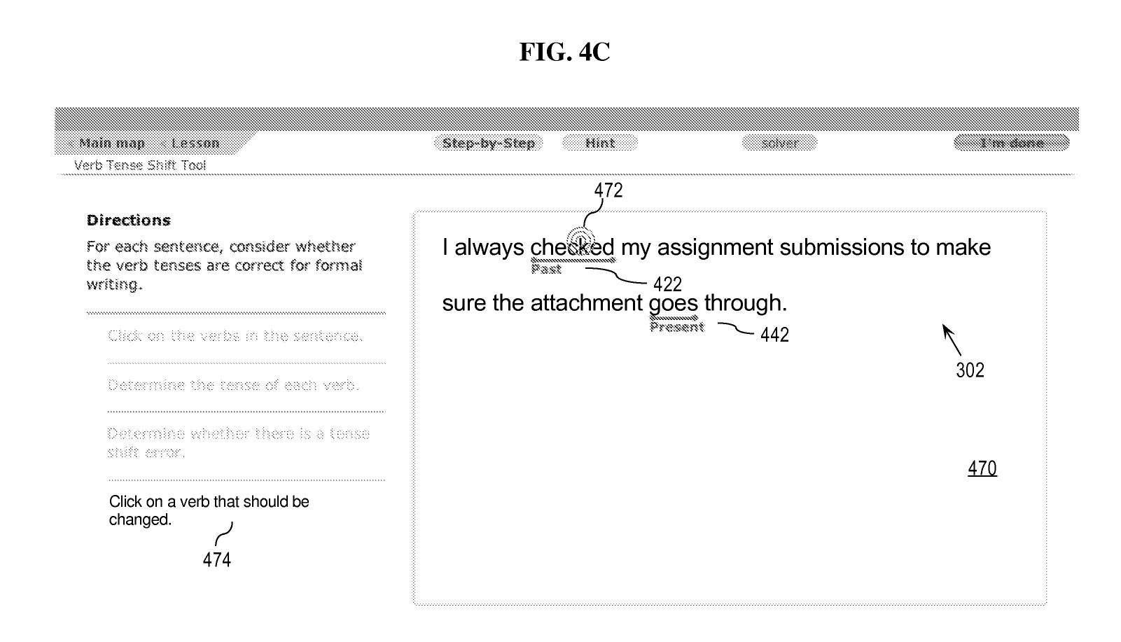

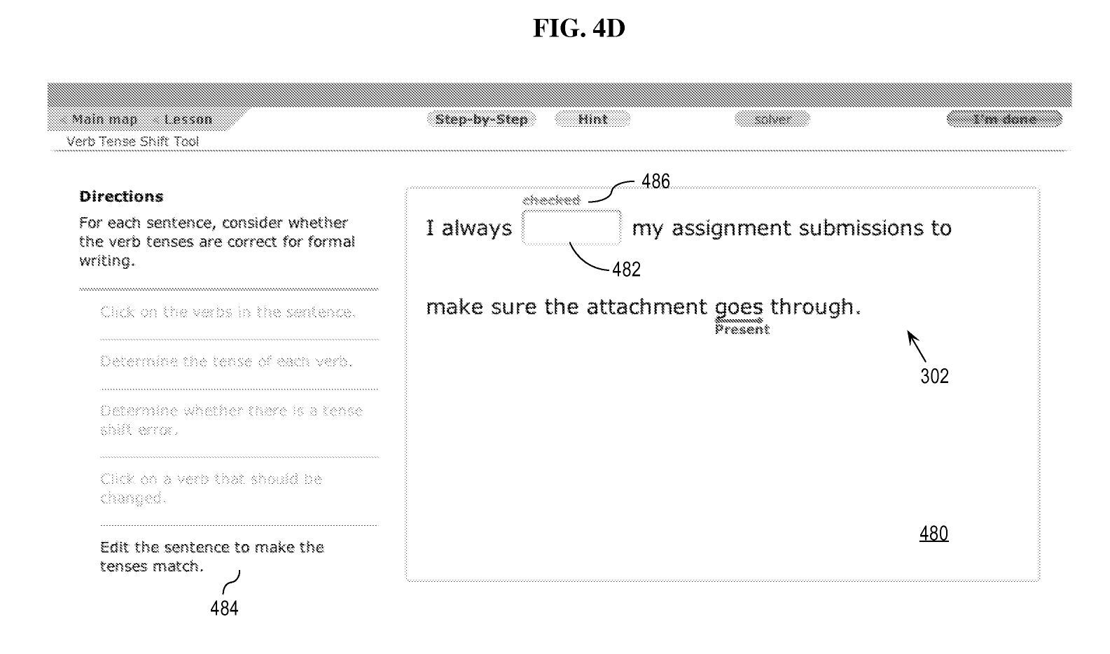

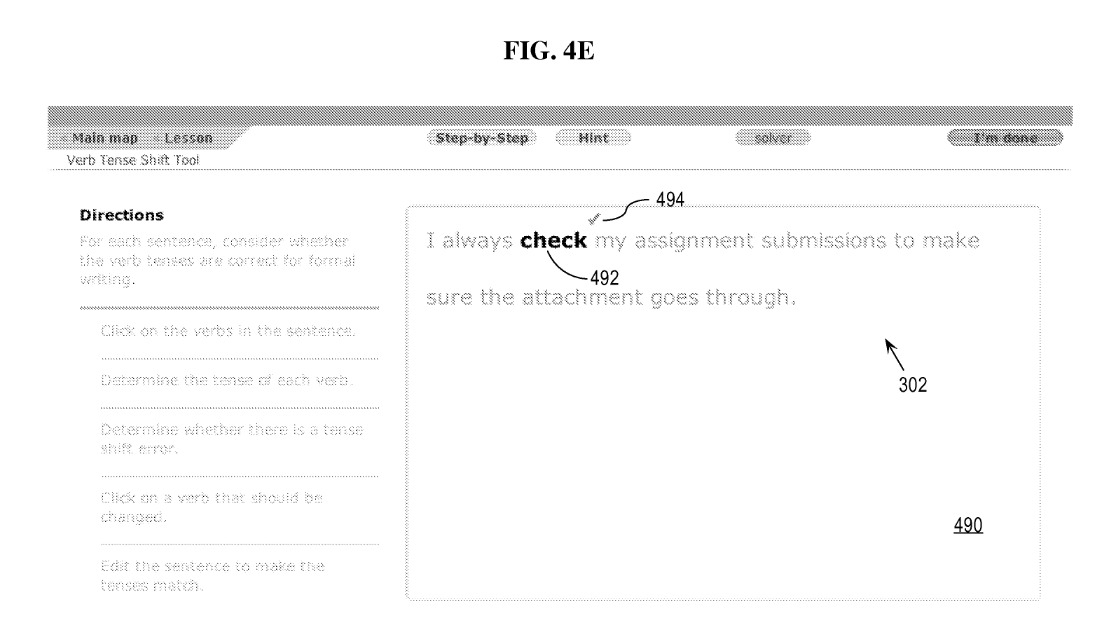

According to an embodiment, verb location service 126 does not move on to another kind of question about sentence 302 (such as the question presented in GUI 400 of FIG. 4A, requesting information about the tenses of the identified verbs) until the user correctly identifies all verbs in sentence 302 via the graphical user interface. According to an embodiment, the user is not required to identify verbs in the infinitive form within a displayed sentence—such as “make” in sentence 302—in order to complete the task of clicking on the verbs in the displayed sentence, since the form of such verbs does not contribute to incorrect tense shift errors.

### Identifying the Tense of Verbs

According to an embodiment, grammar service 122 displays GUI 400 of FIG. 4A with instructions 404 that instruct the user to determine the tense of the identified verbs in displayed sentence 302. In connection with the presented question, verb correction service 124 causes dialog 410 to be displayed, which includes controls 412-416 by which the user may indicate that a particular verb (i.e., “checked”) is in the past tense, present tense, or future tense, respectively. In embodiments, any kind of verb tense may be included in a dialog such as dialog 410. Thus, through GUI 400, the grammar teaching system allows a user to practice verb tense identification. The ability to identify the tenses of verbs is another fundamental granular grammar skill that a user needs in order to properly apply grammatical rules governing verb tense.

Verb correction service 124 receives, via dialog 410, an indication of which control of controls 412-416 that the user activates. In response to receiving this indication, verb correction service 124 determines whether the verb tense associated with the activated control is the correct verb tense for the indicated verb.

For example, verb correction service 124 receives an indication that the user activated control 416, corresponding to future tense, for the verb “checked”. Based on information for the displayed verb tense problem, verb correction service 124 determines that the verb “checked” is actually in the past tense. In response to determining that the user has incorrectly identified the tense of the verb “checked”, verb correction service 124 provides the user with feedback, such as a visual indication that the user has selected the wrong tense (e.g., outlining the verb string in red), displayed information about how to select the correct tense of a verb, etc.

As a further example, verb correction service 124 receives an indication that the user activated control 412, corresponding to past tense, for the verb “checked”. Based on information for the displayed verb tense problem, verb correction service 124 determines that the verb “checked” is in the past tense. In response to determining that the user has correctly identified the tense of the verb “checked”, verb correction service 124 provides the user with feedback, such as a visual indication that the user has selected the correct tense, automatically moving on to the next task for sentence 302 (thus, implicitly indicating that the user has selected the correct verb tense), changing the label on visual highlight 322 to “Past”, etc.

GUI 450 of FIG. 4B depicts visual highlight 422 that labels the verb “checked” with the label “Past” (instead of simply “Verb”) to indicate that the user has correctly identified the tense of “checked” to be past tense. GUI 450 also includes visual highlight 442 that labels the verb “goes” with the label “Present” to indicate that the user has correctly identified the tense of the verb “goes” to be present tense, i.e., in a manner similar to identification of the tense of “checked” described above. According to an embodiment, at least one of visual highlights 422 and 442, with the accompanying label, persists during further questions regarding sentence 302, such as the questions presented in GUIs 470 and 480 of FIGS. 4C and 4D, respectively.

### Identifying the Presence of a Verb Tense Error

According to an embodiment, verb correction service 124 displays instructions 454 (GUI 450) that instruct the user to determine whether there is a tense shift error in displayed sentence 302. In connection with these instructions, verb correction service 124 causes dialog 460 to be displayed, which includes controls 462-466 by which the user may indicate one of the following: that there is a correct shift in verb tense (which is not a verb tense error), that there is an incorrect shift in verb tense (which is a verb tense error), or that there is no change in verb tense (which is not a verb tense error), respectively. In embodiments, any kind of verb tense error may be included in a dialog such as dialog 460.

Allowing a user to indicate whether there is a verb tense error, and more specifically, whether there is an incorrect or correct verb tense shift, allows the user an opportunity to apply the user's reasoning about the tenses of the verbs in the displayed sentence. The ability to recognize a verb tense error, including the ability to recognize the difference between a correct and incorrect verb tense shift, is another fundamental granular grammar skill that a user needs in order to properly apply grammatical rules governing verb tense.

Verb correction service 124 receives, via dialog 460, an indication of which control of controls 462-466 that the user activates. In response to receiving this indication, verb correction service 124 determines whether the user has correctly identified the error status of sentence 302, i.e., as indicated by one of controls 462-466. In the example of sentence 302, the sentence includes an incorrect tense shift verb tense error because the time frames indicated by the verbs “checked” and “goes” do not agree. As such, sentence 302 has an error status of “an incorrect shift in verb tense” corresponding to control 464.

If verb correction service 124 receives information indicating that the user has activated a control other than control 464, then verb correction service 124 determines that the user has selected an incorrect error status for sentence 302. In response to this determination, verb correction service 124 provides the user with feedback, such as a visual indication that the user has selected the wrong error status for sentence 302, information about how to correctly determine the error status of sentence 302, etc.

If verb correction service 124 receives information indicating that the user has activated control 464, “an incorrect shift in verb tense”, then verb correction service 124 determines that the user has selected the correct error status for sentence 302. In response to this determination, verb correction service 124 provides the user with an opportunity to correct the verb tense error, as described in connection with step 204 (of flowchart 200) below. This opportunity to correct the verb tense error implicitly communicates to the user that the user has selected the correct error status for sentence 302.

### Correcting a Verb Tense Error

Returning to flowchart 200 of FIG. 2, at step 204, selection input that selects a particular verb of the at least two verbs within the natural language sentence is received. For example, grammar service 122 displays GUI 470 of FIG. 4C with instructions 474 that instruct the user to identify a verb in sentence 302 that should be changed. In the example of GUI 470, the user is asked to click on one of the verbs in sentence 302, to select which verb should be changed. However, within embodiments, a user may identify the verb to be changed by any identification method, including those indicated above for selecting a verb in sentence 302. As depicted in GUI 470, verb correction service 124 receives user identification of the verb “checked”, as depicted by input 472.

By allowing a user to select which verb to change to correct an incorrect verb shift error in the displayed sentence, the system gives the user flexibility in deciding the sentence's final tense. Such flexibility mirrors the flexibility inherent when the user drafts an original sentence, when the user needs to be able to correctly identify the appropriate tenses for the verbs in the sentence being drafted.

Some sentences, such as sentence 302, include one or more explicit time frame terms that dictate the time frame for at least some of the verbs in the sentence. In example sentence 302, the term “always” indicates a verb time frame of timeless statement or fact. As such, according to the grammar rules of American English, both of the verbs in sentence 302 should be in the present tense, which mirrors the time frame of the term “always” in the sentence.

Because sentence 302 includes an explicit indication of a time frame for the sentence, the user should select and change the verb “checked” to be in the present tense, since selecting and changing the verb “goes” to be in the past tense would cause both verbs to not agree with the time frame explicitly set by the sentence. According to an embodiment, verb correction service 124 provides the user with the opportunity to select which verb that the user will correct in sentence 302 and, if the user selects “goes” to change, provides the user with feedback indicating that the sentence has an explicit time frame set by the term “always” and explains that the verb “checked” should be changed rather than “goes”. In this embodiment, verb correction service 124 may also highlight any terms in the displayed sentence that explicitly indicate time frame (i.e., “always” in sentence 302). As a further example of explicit time frame indicators, when a particular sentence includes reference to a published article, any reference to the content of the published article is present tense, e.g., “As Karl Marx says in Das Kapital, . . . ”.

According to another embodiment, if correction of a particular displayed sentence requires changing a particular verb of the two or more verbs identified in the sentence (as with sentence 302), then verb correction service 124 automatically selects the verb that must be corrected for correction. For example, verb correction service 124 automatically selects the verb “checked” in sentence 302 for the user to correct, without requiring the user to perform the selection. Thus, verb correction service 124 automatically displays a control that allows the user to specify a replacement for “checked”, as described in further detail below.

Many other sentences would allow the user to identify any verb within the sentence for correction. For example, if sentence 302 read as follows, then the user may select either of “checked” or “goes” for correction: “I checked my assignment submissions to make sure the attachment goes through.” Since there is no explicit indication of time frame in this version of the sentence, the user is not restricted as to which verb the user should choose to correct.

At step 206 of flowchart 200, in response to receiving the selection input, a control that allows a user to specify a replacement for the particular verb in the natural language sentence is provided. For example, in response to the user selecting the verb “checked”, i.e., via input 472, verb correction service 124 causes control 482 to replace the depiction of the verb “checked” as shown in GUI 480 of FIG. 4D. Within embodiments, control 482 may accept input of a corrected verb in a variety of ways, such as by: allowing a user to type in a replacement string, allowing a user to submit a spoken correction via speech recognition technology, allowing a user to select an option from a drop-down list, etc. Also, verb correction service 124 displays instructions 484 to instruct the user to edit sentence 302 to make the verb tenses match.

Further, in the example of GUI 480, control 482 is labeled with label 486, which depicts the verb that the user has chosen to replace (i.e., “checked”). Label 486 is styled to communicate that the label depicts the verb to be replaced, and to communicate that the label is not a hint as to what the verb should be replaced with. Specifically, label 486 is grayed out and also crossed out. Other styling may be used to set label 486 apart from other communications in GUI 480.

Verb correction service 124 receives, via control 482, a replacement string from the user that represents one or more words that the user would like to replace the selected verb. For example, a user types a string such as “checking”, “monitor”, or “check” into control 482.

At step 208, it is determined whether the replacement is included in a set of one or more verb corrections for the particular verb in information that is maintained for the natural language sentence. For example, verb correction service 124 determines whether the replacement string that the user provided via control 482 represents a verb correction in a set of one or more accurate verb corrections for the verb “checked” in data for the displayed problem (i.e., from database 140). In an embodiment, there is only one verb correction that is indicated as accurate for the particular verb in information maintained for sentence 302 in database 140.

To illustrate, if the user inputs the string “checking” via control 482, verb correction service 124 determines whether “checking” is one of the accurate corrections for the verb “checked” in sentence 302. In this example, the set of accurate corrections for the verb “checked” in data for sentence 302 includes only the correction “check”. As such, verb correction service 124 determines that the replacement string “checking” is not included in the set of verb corrections for the verb “checked”. In response to this determination, verb correction service 124 provides the user with feedback, such as a visual indication that the user has input an inaccurate correction for the verb “checked”, information about how to accurately correct the tense of the verb, etc.

As a further illustration, if the user inputs the string “monitor” via control 482, verb correction service 124 determines that the replacement string “monitor” is not an accurate correction of the verb “checked”, since “monitor” is not included in the set of accurate corrections for “checked”. According to an embodiment, verb correction service 124 further determines that “monitor” is not a form of the verb that the user is tasked with replacing, i.e., to check. In this embodiment, in addition to providing feedback indicating that the user has not accurately corrected sentence 302 (as indicated above), verb correction service 124 also provides feedback indicating that the user should provide a replacement string that is a form of the same verb as the verb being replaced.

As yet a further illustration, the user inputs the string “check” via control 482. When verb correction service 124 receives this replacement string, verb correction service 124 determines whether “check” is one of the accurate corrections for the verb “checked” in sentence 302. Since the set of accurate corrections for the verb “checked” includes the correction “check”, verb correction service 124 determines that the user has accurately corrected the tense of the verb “checked” in sentence 302.

At step 210, in response to determining that the replacement is included in the set of one or more verb corrections for the particular verb, one or more of the following are performed: communicate successful sentence correction to the user, and record information indicating successful sentence correction of the natural language sentence. For example, in response to determining that “check” is an accurate correction of the verb “checked” in sentence 302, verb correction service 124 communicates successful sentence correction to the user, an example of which is depicted in GUI 490 of FIG. 4E.

GUI 490 includes a depiction 492 of the replacement string provided by the user in the place where the verb “checked” used to be depicted within sentence 302. Further, depiction 492 is depicted with font features that distinguish depiction 492 from the rest of the words in sentence 302 (i.e., depiction 492 is black and bolded, where the rest of the words in sentence 302 are not bolded and are grayed out). Such a depiction of the replacement string implicitly communicates to the user that the user has input an accurate correction of the verb tense of “checked”. Also, GUI 490 includes icon 494, which is a green check mark. Icon 494 is an explicit indication of a correct answer to the question of verb tense correction.

According to an embodiment, in response to determining that the user has accurately corrected the tense of the verb “checked” in sentence 302, verb correction service 124 records information indicating the successful correction. For example, instead of or in addition to communicating successful sentence correction to the user, verb correction service 124 records information, e.g., in database 140, that the user has successfully corrected the incorrect verb tense shift error in sentence 302. Such information may be used to aid in selection of verb tense problems to display to the user in the future, to create a summary of the user's progress, etc.

### Correcting a Verb Tense Error in a Multiple-Sentence Paragraph

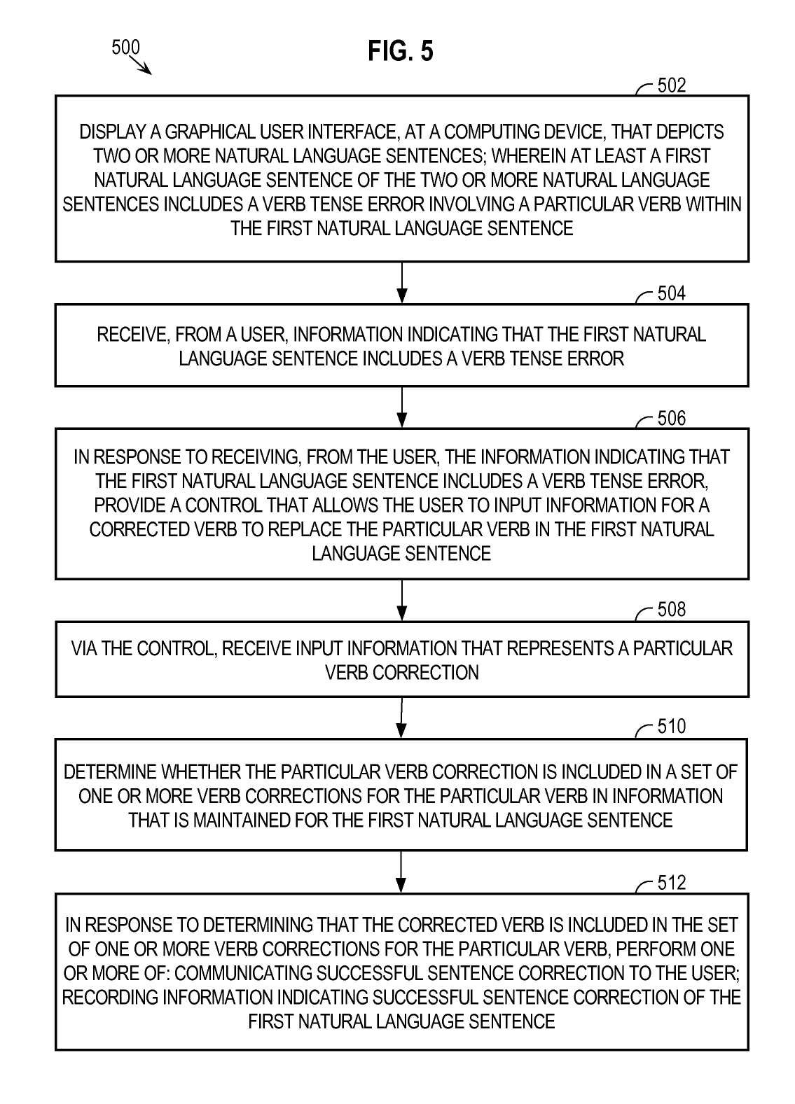

According to an embodiment, at least some of the verb tense problems in database 140 include data for multiple sentences that are configured to be presented all together to a user, i.e., in paragraph form. FIG. 5 is a flowchart 500 for presenting a verb tense problem with multiple sentences to a user and allowing the user to correct one or more verb tense errors in the displayed sentences.

At step 502 of flowchart 500, a graphical user interface that depicts two or more natural language sentences is displayed at a computing device, wherein at least a first natural language sentence of the two or more natural language sentences includes a verb tense error involving a particular verb within the first natural language sentence. For example, GUI 600 of FIG. 6A depicts multiple sentences 602-606, where at least natural language sentence 602 includes a verb tense error involving the verb string 608 (“have identify”). Any particular sentence of a multiple natural language sentences in a verb tense problem may include a verb tense error. Further any particular sentence of a multiple natural language sentences in a verb tense problem may be free of verb tense errors.

At step 504, information indicating that the first natural language sentence includes a verb tense error is received from a user. For example, verb correction service 124 displays dialog 610 that instructs the user to choose the correct description of verb string 608. Dialog 610 further includes a control 612 that corresponds to the input “verb error” and a control 614 that corresponds to the input “no error”. The inputs assigned to controls 612 and 614 are illustrative and non-limiting within embodiments. Verb correction service 124 receives information indicating that the user has activated one of controls 612 and 614, which informs verb correction service 124 that the user has designated verb string 608 to be in error, or to be not in error, respectively.

According to an example, the user activates control 612. Verb correction service 124 receives information indicating that the user has activated control 612, by which the user indicates that sentence 602 includes a verb tense error at verb string 608.

At step 506, in response to receiving, from the user, the information indicating that the first natural language sentence includes a verb tense error, a control is provided that allows the user to input information for a corrected verb to replace the particular verb in the first natural language sentence. For example, verb correction service 124 receives information, via dialog 610, indicating that the user has activated control 612, which informs verb correction service 124 that the user has designated verb string 608 to be in error. In response to receiving this information, verb correction service 124 replaces the depiction of the verb string “have identify” in sentence 602 with control 622, as depicted in GUI 620 of FIG. 6B.

Within embodiments, control 622 allows the user to specify a replacement for a verb in any manner, including allowing selection of a replacement from a list, using speech recognition technology to allow the user to speak a replacement for the verb, allowing a user to type in a verb correction string, etc. Furthermore, control 622 is labeled by label 624, which indicates to the user that control 622 replaced the verb string “have identify”, indicated in label 624. Label 624 is displayed using font style elements that communicate to the user that the label represents the phrase being replaced and is not a hint, i.e., the lettering of label 624 is grayed out and also struck through.

At step 508, input information that represents a particular verb correction is received via the control. For example, verb correction service 124 receives the string “have identified” via control 622. The received string is a verb correction string that a user has input via control 622.

At step 510, it is determined whether the particular verb correction is included in a set of one or more verb corrections for the particular verb in information that is maintained for the first natural language sentence. For example, verb correction service 124 determines whether the verb correction string “have identified” is included in a set of verb corrections for the original verb string “have identify” (of sentence 602) in information for the verb tense problem, i.e., from database 140. Verb correction service 124 determines that the set of verb corrections for “have identify” in data for sentence 602 includes the phrase “have identified”. As such, verb correction service 124 determines that “have identified” is an accurate correction of the verb string “have identify” in sentence 602.

At step 512, in response to determining that the corrected verb is included in the set of one or more verb corrections for the particular verb, one or more of the following are performed: communicating successful sentence correction to the user, and recording information indicating successful sentence correction of the first natural language sentence.

According to an embodiment, in response to determining that the verb correction string “have identified” is in the set of verb corrections for the original verb string “have identify” of sentence 602, verb correction service 124 communicates successful sentence correction to the user. For example, GUI 630 of FIG. 6C includes a depiction 632 of the verb correction string provided by the user in the place where the verb string “have identify” was previously depicted within sentence 602. Depiction 632 implicitly communicates to the user that the user has successfully corrected the tense of the indicated verb string. Further, depiction 632 is depicted with font features that distinguish depiction 632 from the rest of the words in sentence 602 (i.e., depiction 632 is black and bolded, where the rest of the words in sentence 602 are not bolded and are grayed out in GUI 630). Such a depiction of the verb correction string also implicitly indicates to the user that the user has input an accurate correction of the verb tense.

Also, GUI 630 displays a mechanism to analyze the subsequent sentence 604, which also implicitly indicates to the user that the user has input an accurate correction of the verb string in sentence 602. According to embodiments, communication of successful sentence correction to a user may be accomplished in any manner, including displaying a message that states that the user's answer is correct, playing a sound that indicates that the user is correct, etc.

According to an embodiment, in response to determining that the corrected verb string represents an accurate correction of the verb string “have identify” in sentence 602, verb correction service 124 records information indicating successful sentence correction of sentence 602. For example, instead of or in addition to communicating successful sentence correction to the user, verb correction service 124 records information, e.g., in database 140, that the user has successfully corrected the verb tense error in sentence 602. Such information may be used to aid in selection of verb tense problems to display to the user in the future, or to create a summary of the user's progress, etc.

According to an embodiment, if the verb correction string, input via control 622 of GUI 620, is not in the set of accurate corrections for the indicated verb, then verb correction service 124 provides feedback to the user regarding the inaccurate verb correction string. For example, as depicted in GUI 640 of FIG. 6D, the user inputs “has identified” via control 622. Verb correction service 124 determines that “has identified” is not an accurate correction of “have identify” in sentence 602 because “has identified” is not in the set of accurate corrections for the verb.

In response to determining that the input verb correction string is not an accurate correction of “have identify” in sentence 602, verb correction service 124 provides feedback, such as one or more visual cues that the input correction string is inaccurate, e.g., displaying an icon, depicting the verb correction string with a particular style of font, displaying a visual indicator integrated with control 622 such as outlining control 622 in a particular color, etc.

Furthermore, the feedback may include information about the verb correction string, i.e., at information box 642. According to the embodiment depicted in GUI 640, information box 642 includes information about how to formulate an accurate correction of “have identify” in natural language sentence 602. Information box 642 includes information that is specific to the verb correction string “has identified”, and may include information such as an acknowledgement that the verb correction string is a tense of the given verb. Verb correction service 124 retrieves the verb-specific information for information box 642 from (or based on) data for the displayed verb tense problem.

According to an embodiment, verb correction service 124 determines that a verb correction string (such as “has identified”) is in the correct tense, but does not agree with the plurality of the subject of the sentence (“Alberto and Natalie”). As such, verb correction service 124 provides feedback to the user that instructs the user about agreement between the verb form and the subject of the sentence. In the example of GUI 640, verb correction service 124 provides the user with information stating that the verb correction string input by the user is in the correct tense, but should agree with the third-person plural subject (“Alberto and Natalie”). As such, verb correction service 124 provides sentence-specific feedback regarding number agreement between the subject and the verb.

As a further example, the user inputs “to identify” into control 622. Verb correction service 124 determines that “to identify” is not an accurate correction of “have identify” in sentence 602 because “to identify” is not in the set of accurate corrections for the verb. In response to determining that “to identify” is not an accurate correction of the indicated verb, verb correction service 124 provides feedback to the user as described above.

In the example feedback depicted in GUI 650 of FIG. 6E, verb correction service 124 displays information box 652, which includes information that is not specific to the verb correction string “to identify”. According to embodiments, if verb correction service 124 identifies no information that is specific to the verb correction string input by the user from information for the displayed verb tense problem, then verb correction service 124 displays default feedback information, such as the information in information box 652. Default feedback information indicates to the user that the input verb correction string is incorrect. Default feedback information may also include instructions for how to identify an accurate verb tense correction (i.e., “consider the sentence and its context in the paragraph”). Furthermore, in an embodiment, if verb correction service 124 determines that the verb correction string is not a form of the verb being corrected, then in addition to any other feedback, verb correction service 124 provides the user with feedback indicating that the user should input a form of the provided verb.

According to an embodiment, if verb correction service 124 determines that a verb correction string input by the user represents a version of the verb that is never correct, then verb correction service 124 provides the user with feedback that is specific to the error that the user committed. For example, the verb that the user is attempting to correct is “to write” and the user provides the verb correction string “have wrote” (which is a form of “to write” that is never correct). When verb correction service 124 receives this verb correction string, verb correction service 124 determines that the verb correction string “have wrote” is always erroneous based on one or more of data maintained for the verb in connection with the displayed verb tense problem, data maintained for the verb in a verb database within database 140, etc. From the data maintained for the verb, verb correction service 124 retrieves information to display to the user as feedback for this erroneous form of the verb. Such information provides feedback to teach the user that the form of the verb input by the user is never correct, and may also include proper alternatives to the incorrect form.

As depicted in GUI 630 of FIG. 6C, once a user has accurately corrected the verb tense error of sentence 602, verb correction service 124 automatically moves on to sentence 604. In the example of GUI 630, verb correction service 124 automatically presents dialog 634 that allows the user to input information designating whether a verb string 636 “have took”, which is automatically highlighted within sentence 604, has a verb tense error in a manner that is similar to the manner described for dialog 610 of GUI 600. Verb correction service 124 allows the user to input a verb correction for the verb tense error(s) identified in the displayed sentences as described above.

According to an embodiment, verb correction service 124 automatically highlights and initiates questions about particular verb strings in a set of multiple displayed sentences in a predetermined order. For example, the data for a displayed problem indicates that a particular verb in each displayed sentence, in turn, should be highlighted. When each verb is highlighted, verb correction service 124 also displays a mechanism whereby the user may indicate whether the verb has a verb tense error as described above.

According to an embodiment, at least one of the displayed multiple sentences does not include a verb tense error. In this embodiment, verb correction service 124 automatically highlights a verb string in a displayed sentence that does not include a verb tense error and displays a mechanism whereby the user may indicate whether the highlighted verb has a verb tense error. Verb correction service 124 automatically moves on to any remaining verb strings to be highlighted in response to the user indicating that the verb string does not have a verb tense error.

According to an embodiment depicted in GUI 660 of FIG. 6F, once a user has accurately corrected all of the displayed verb strings that have verb tense errors, verb correction service 124 presents the user with information that highlights and displays all of the corrected verb strings (i.e., phrases 662, 664, and 666). According to an embodiment, verb correction service 124 provides the user with summary information about the displayed verb tense problem after the user has completed all of the verb string corrections for the problem.

### Optional Tasks

According to an embodiment, grammar service 122 provides a set of optional tasks to guide a user through identifying an accurate correction for a particular verb tense error. The optional tasks step the user through the reasoning needed to identify an accurate correction, and provide details and help that are specific to the verb string and sentence in question.

A user is not required to complete the optional tasks associated with a particular verb tense problem in order to complete the problem. As such, a user may apply skills and intuition to problems presented to the user in a way that is most natural to the user, without unnecessarily performing the steps presented in the optional tasks. Nevertheless, if a user is having trouble reasoning through the steps needed to complete a problem, the user may engage the optional tasks to provide needed details. At any point in the optional tasks, the user may input a verb correction into the provided control.

According to an embodiment, if a user has not completed the optional tasks for a particular problem and the user provides an incorrect answer for the problem, then verb correction service 124 provides feedback to the user suggesting that the user complete the optional tasks for the problem, in addition to or instead of any other feedback. However, if the user gives an incorrect answer and has already completed the optional tasks for the problem in question, feedback for the incorrect answer does not include a suggestion to complete the optional tasks.

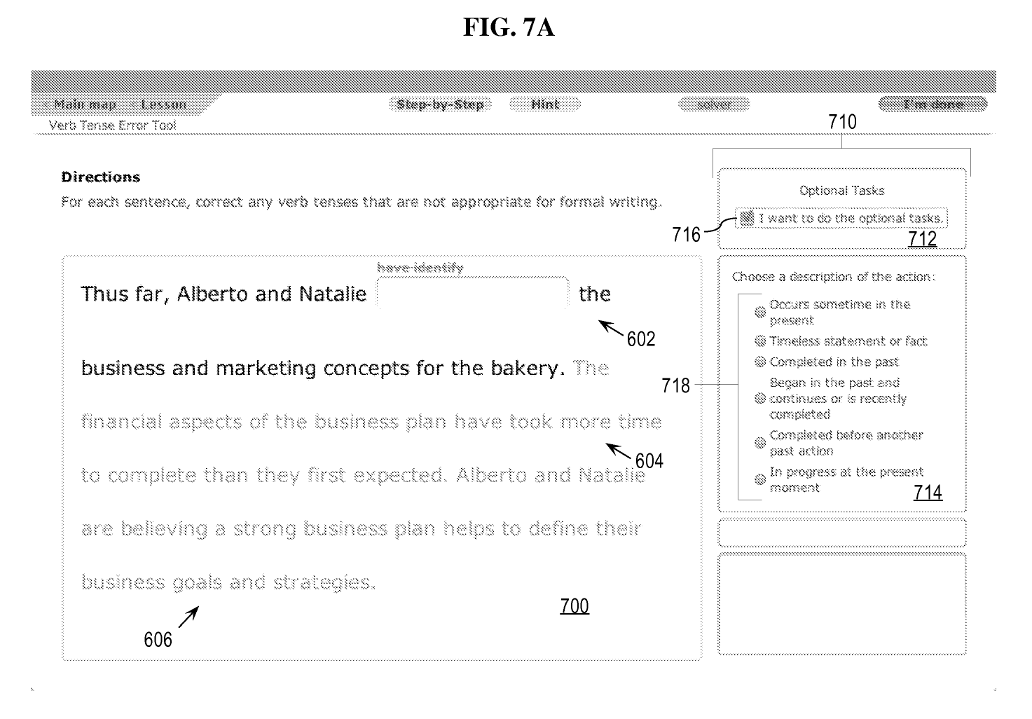

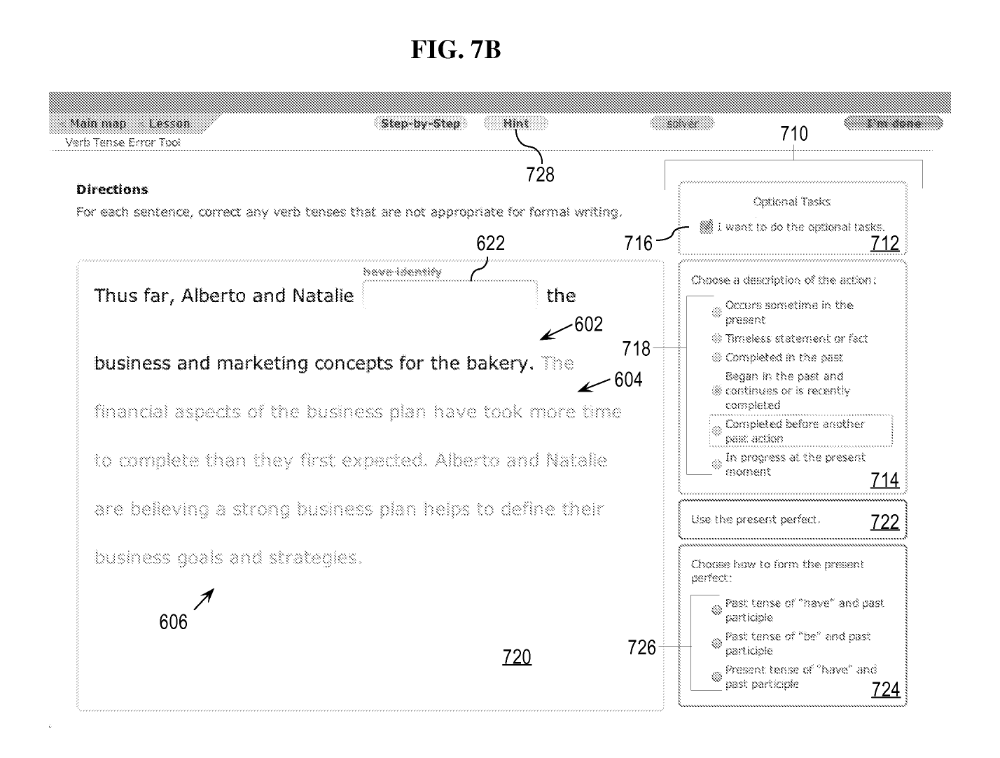

GUI 700 of FIG. 7A depicts an optional tasks side panel 710 with multiple subpanels, including subpanels 712 and 714. In the example of GUI 700, a user has selected the option control 716 that indicates that the user wants to perform the optional tasks for the problem in question. In contrast, GUI 620 of FIG. 6B includes an optional tasks side panel that corresponds to optional tasks side panel 710, but a user has not selected the option control that corresponds to option control 716. As such, the subpanels of the optional tasks side panel remain unpopulated in GUI 620.

Returning to the example of GUI 700, in response to detecting that the user has selected option control 716, optional tasks service 128 populates subpanel 714 with controls 718 that allow the user to designate a description of a time frame of the action being performed in the verb string that the user is currently attempting to correct (i.e., “have identify” in sentence 602). Each of controls 718 corresponds to a distinct time frame for the action being performed in sentence 602.

If the user activates a control of controls 718 that does not accurately describe the time frame of the verb string or of the sentence in question (i.e., “have identify” in sentence 602), then optional tasks service 128 communicates to the user that the user has selected the wrong control, e.g., using a visual indicator (such as a red outline of the incorrectly selected control, an icon, etc.), text that gives information that includes that the incorrect control was selected, a sound that communicates that the selected control is incorrect, etc. According to an embodiment, text that optional tasks service 128 displays includes information about how to pick the correct time frame. Subsequently, the user is allowed to activate another control of controls 718 to continue the attempt to select the correct time frame for the verb string in question.

If the user activates a control of controls 718 that accurately describes the time frame of the verb string in question, then optional tasks service 128 communicates to the user that the user has selected a correct control of controls 718. For example, optional tasks service 128 displays a visual indicator of success, plays a sound that indicates success, implicitly indicates the user's success, etc. For example, optional tasks service 128 populates further subpanels in optional tasks side panel 710, as depicted in GUI 720 of FIG. 7B, which implicitly communicates that the user has successfully picked a control that describes the correct time frame of the verb string in question.

Specifically, GUI 720 depicts user selection of a control, of controls 718, that corresponds to “began in the past and continues or is recently completed”, which accurately describes the action of the verb string of sentence 602 that the user is currently attempting to correct. In response to determining that the user has selected the correct control of controls 718, optional tasks service 128 populates subpanel 722 with information indicating the name of the verb tense that should be used with the time frame that characterizes the action of the verb string to be corrected. This information allows the user to become familiar with the names of the tenses being taught. Furthermore, if the user is already familiar with the names of verb tenses, presentation of the name of the correct verb tense may be sufficient information for the user to complete correction of the verb string without completing further optional tasks.

In response to determining that the user has selected the correct control of controls 718, optional tasks service 128 also populates subpanel 724 with controls 726, which are three options for forming the verb tense needed to correct the verb string in question (i.e., “have identify” of sentence 602). The information presented in subpanel 724 may be considered a multiple choice question, and, according to an embodiment, the distractors for this multiple choice question are identified as described in further detail below.

According to embodiments, if optional tasks service 128 detects that the user has selected a particular control, of controls 726, that is not the correct way to formulate a verb of the given tense, then optional tasks service 128 communicates to the user that the selected control is incorrect in any manner as described herein, including by providing details about how to correctly formulate the given verb tense, automatically displaying hint information for the step of the optional tasks corresponding to subpanel 724, etc. If optional tasks service 128 detects that the user has selected a particular control, of controls 726, that is the correct way to formulate a verb of the given tense, then optional tasks service 128 communicates to the user that the selected control is correct in any manner as described herein.

At any point in the optional tasks, the user may request a hint about the current optional task, e.g., by activating hint button 728. Further, hint information is available for each step in solving any verb tense problem as described herein by activating hint button 728. According to an embodiment, when a user makes a mistake in connection with a verb tense problem or optional tasks, grammar service 122 visually highlights hint button 728 to remind the user that this hint option is available.

Once the user has successfully corrected the current verb string in question, grammar service 122 automatically moves on to any other verb strings of the currently displayed problem that the user has not yet corrected. At that point, the subpanels of optional tasks side panel 710 clear out and option control 716 is deselected in preparation for providing optional tasks that are specific to the next verb string in question.

### Verb Tense Error Formulation

According to an embodiment, incorrect verb tenses within verb tense problems in database 140 are formulated based, at least in part, on analysis of a corpus of information that indicate actual errors that are made by students. Analysis of such a corpus identifies common errors for particular verb tense situations. For example, such analysis indicates that, when a particular verb string should be in the past tense (e.g., “chose”), students tend to erroneously use one of: present tense (“choose”); present progressive tense (“is choosing”); present passive tense (“is chosen”); or past participle alone (“chosen”).

Thus, if a particular natural language sentence in a verb tense problem should have a past tense verb, the verb in the proper tense is replaced with an erroneous verb string, where the erroneous verb string is either one of the valid verb forms that students commonly misuse in the situation, or one of the malformed verb strings that students commonly produce. In the context of the example above, a verb string in the past tense is replaced, e.g., with the present passive form of the verb.

Similarly, multiple choice verb tense problems in database 140 include distractors that are based on verb tenses that students tend to erroneously use, as identified by analysis of the corpus of information described above. A distractor of a multiple choice problem is a plausible, but incorrect, option for the multiple-choice answer. In an embodiment, database 140 includes a list of common mistakes for formulating a particular verb tense. When grammar service 122 displays a multiple choice problem to a user, grammar service 122 determines the verb tense being tested by the question and automatically formulates distractors for the multiple choice question based on one or more of the list of common mistakes for the particular verb tense. Thus if the erroneous sentence is, “The Great Depression is beginning in 1929,” then the multiple choice list presented to the student might include the distractors “is begun” (present passive tense), “begins” (present tense), and “begun” (past participle alone) along with the correct answer “began” (past tense).

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

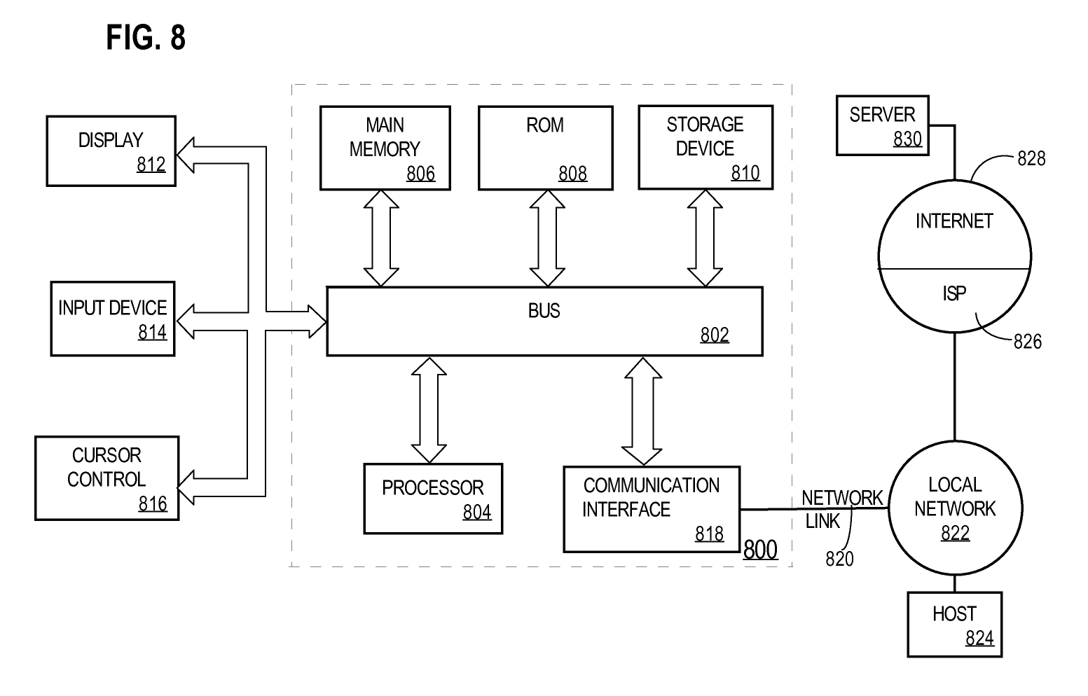

For example, FIG. 8 is a block diagram that illustrates a computer system 800 upon which an embodiment of the invention may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media are distinct from but may be used in conjunction with transmission media. Transmission media participate in transferring information between storage media. For example, transmission media include coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Given the interaction design, a model is built that describes in machine-readable fashion what the various components in the system, the properties that they have, and the values that those properties can take. A fragment of this model, in textual form, might look like this:
Type: TENSE_SHIFT_PROBLEM: The problem type where students are dealing with verb tenses which agree or disagree.

Properties:
sentence (SENTENCE):
   The sentence that this problem deals with.
      Type: SENTENCE: A package of a sentence (with tags marking parts of speech of various phrases), and the possible fixes for that sentence (if it has an error).

Properties:
verbs (LIST<VERB>):
   A list of all verbs in the sentence.
tagged-words (STRING):
   The words in the sentence. Includes square-bracketed XML (like [noun] . . . [/noun]) to indicate parts of speech of phrases.
words (STRING):
   The words in the sentence. Equal to tagged-words minus the bracketed XML tags.
tense-shift (TENSE_SHIFT_TYPE):
   The type of agreement or disagreement of the verbs in the sentence.
verb-tense-tcp-representation (STRING):
   A specially-formatted representation of the verbs and their tenses to be read by the user interface code.
sentence-structures-tcp-representation (STRING):
   A specially-formatted representation of all parts of the sentence that might need to be underlined, designed to be read by the user interface code.
pseudoverbs (PSEUDOVERB):
   Words in the sentence that the student might be tempted to identify as verbs because they are verbs in other contexts, though not used as verbs in this sentence (e.g., if the sentence was “He won the vote.”, “vote” would be a pseudoverb).
      Type: TENSE_SHIFT_TYPE: The possible relationships between two verbs in a sentence

Values:
_noShift: Both verbs have the same tense (e.g. both are past tense).
_incorrectShift: The tenses aren't the same and the sentence is ungrammatical.
_correctShift: The tenses aren't the same but the sentence is grammatical.
   Type: VERB: A container for a verb and its associated properties, including all of its tenses

### Selected Properties:

current-time (VERB_TIME):
For TENSE_SHIFT_PROBLEMs, time/tense of the verb as initially presented (regardless of whether that is correct or not).

number (PLURALITY):
Number of the subject of this verb: singular or plural.

past-participle (STRING):
Past participle of the verb, used as part of the present perfect and past perfect.

past-perfect (STRING):
Past perfect form of this verb.

past-tense (STRING):
Correct past tense of the verb given properties of the subject of the verb.

past-tense-generic (STRING):
“Generic” past tense of the verb. For all verbs except “be,” this is the past tense regardless of person and number.

plain-form (STRING):
The plain form of the verb; that is, the infinitive without the “to.”

possible-corrections (LIST<STRING>):
Accepted answers for correcting a given verb.

present-participle (STRING):
Present participle of the verb, used as part of the progressive.
   The domain model further describes the tutoring domain: the different types of tasks that the student will perform in the course of solving a problem. A fragment of this model in textual form looks like this:
   Type: IDENTIFY_SHIFT_GN: A GN where the student is identifying whether or not there is a shift in verb tense between the two verbs in the sentence.

Selected Properties:
answer (TENSE_SHIFT_TYPE):
   The correct answer.
auto-help (NUMBER):
   Which hint to give automatically if student gets this wrong.
hint-level-1 (STRING):
   Text of the first hint a student can see.
hint-level-2 (STRING):
   Text of the second hint a student can see.

### Problem Authoring

In parallel with the domain authoring activity, subject matter experts (SMEs) write and encode a set of paragraphs (for one problem type) and sentences (for the other problem type), some of which contain the kinds of verb tense errors that students tend to make and all of which employ verb tenses students are known to struggle with. Based on research, the common student errors can be grouped into two categories:

1. Malformations:
present participle alone instead of present tense
present tense of “be” plus present tense instead of present tense
past participle alone instead of past tense
present tense of “have” plus present tense instead of present perfect
present tense of “have” plus past tense instead of present perfect
“having” plus past participle instead of present perfect
past tense of “have” plus present tense instead of past perfect
past tense of “have” plus past tense instead of past perfect
present participle alone instead of present progressive
present tense of “be” plus present tense instead of present progressive
present tense of “be” plus present participle instead of present progressive

2. Inappropriate tense choices:
present tense instead of past tense
past tense instead of present tense
past perfect instead of past
present perfect instead of present
present progressive instead of present
   The SME encodes the grammatical role played by various phrases in the sentence as well as various properties of each verb. These properties are used to create customized hints and feedback for this verb and to identify which grammatical skills the student must use in this sentence. If the sentence contains an error for the student to fix, the SME further encodes the location and type of the error, and which forms of the verb are acceptable corrections in this case. An example of a single sentence from an encoded paragraph is:

| | |
|---|---|
| Problem | VT_JM_31 |
| ScenarioTag | Board_Games_JM |
| Sentence | Whenever I visit, my nieces and nephews |
| | have liked to play board games with me. |
| timeCue | Whenever |
| text | visit |
| fixType | noError |
| plainForm | visit |
| person | first |
| number | singular |
| pastTenseEnding | ed |
| timeFrame | timeless |
| steadyState | false |
| timeCues | Whenever |
| text | have liked |
| fixType | wrongTense |
| fixes | like |
| plainForm | like |
| person | first |
| number | plural |
| pastTenseEnding | d |
| timeFrame | timeless |
| publishedArticle | false |
| steadyState | true |
| timeCues | Whenever |

An example of a single sentence problem is:

| | |
|---|---|
| problem | VS_JM_11 |
| scenarioTag | Pay_Loans_JM |
| sentence | In order to pay my student loans on |
| | time, I made a monthly budget, and I |
| | enroll in an online banking program. |
| errorType | incorrectShift |
| pseudoverb | order |
| infinitiveVerb | pay |
| pseudoverb | loans |
| pseudoverb | time |
| pseudoverb | banking |
| pseudoverb | program |
| text | made |
| fixes | make |
| plainForm | make |
| person | first |
| number | singular |
| pastTenseEnding | irregular |
| timeFrame | past |
| publishedArticle | false |
| steadyState | false |
| text | enroll |
| fixes | enrolled |
| plainForm | enroll |
| person | first |
| number | singular |
| pastTenseEnding | ed |
| timeFrame | present |
| publishedArticle | false |

### Generation

These problem scenarios are then converted into problem templates in an existing problem generation infrastructure. In the multiple-sentence problems, individual problem instances are created by selecting a subset of the paragraph written by the SME. A function finds and fills in other basic tenses of each verb, based on the verb's plain form supplied by the SME. Another function surrounds key words and phrases in the sentence with tags as to the type of each word or phrase. When this conversion has been completed for the first sentence above, it looks like this:

In [_pseudoverb]order[/_pseudoverb] to
[_infinitiveVerb]pay[/_infinitiveVerb] my student
[_pseudoverb]loans[/_pseudoverb] on
[_pseudoverb]time[/_pseudoverb], I [_verb]make[/_verb]
a spreadsheet of my expenses each month, and I
[_verb]use[/_verb] an online [_pseudoverb]banking[/_pseudoverb]
[_pseudoverb]program[/_pseudoverb].

and the verbs look like this:

<Property name=“verbs”>

<ValueStructure container_type=“VERB”>

<Property name=“words” value=“make”/>
<Property name=“person” value=“_first”/>
<Property name=“number” value=“_singular”/>
<Property name=“plain-form” value=“make”/>
<Property name=“past-tense-generic” value=“made”/>
<Property name=“past-tense-ending” value=“_irregular”/>
<Property name=“past-participle” value=“made”/>
<Property name=“present-participle” value=“making”/>
<Property name=“present-tense-third-singular” value=“makes”/>
<Property name=“timeframe” value=“_present”/>
<Property name=“steady-state” value=“False”/>
<Property name=“published-article” value=“False”/>
<Property name=“possible-corrections”>

<Value>made</Value>

</Property>

</ValueStructure>
<ValueStructure container_type=“VERB”>

<Property name=“words” value=“use”/>
<Property name=“person” value=“_first”/>
<Property name=“number” value=“_singular”/>
<Property name=“plain-form” value=“use”/>
<Property name=“past-tense-generic” value=“used”/>
<Property name=“past-tense-ending” value=“_d”/>
<Property name=“past-participle” value=“used”/>
<Property name=“present-participle” value=“using”/>
<Property name=“present-tense-third-singular” value=“uses”/>
<Property name=“timeframe” value=“_present”/>
<Property name=“steady-state” value=“False”/>
<Property name=“published-article” value=“False”/>
<Property name=“possible-corrections”>

<Value>used</Value>

</Property>

</ValueStructure>

This problem generation infrastructure then outputs XML files that represent each problem instance in terms of the domain model previously described.

What is claimed is:

1. A computer-executed method comprising:
generating a display of a graphical user interface that depicts a natural language sentence;
wherein the natural language sentence includes at least two verbs;
wherein the natural language sentence includes one or more verb tense errors;
receiving selection input that selects a particular verb of the at least two verbs within the natural language sentence;
providing a control that allows a user to specify a replacement for the particular verb in the natural language sentence;
receiving, by use of the control, input that specifies the replacement for the particular verb;
determining whether the replacement is included in a set of one or more verb corrections for the particular verb in information that is maintained for the natural language sentence; and
in response to determining that the replacement is included in the set of one or more verb corrections for the particular verb, performing one or more of:
communicating successful sentence correction to the user, or
recording information indicating successful sentence correction of the natural language sentence;
wherein the method is performed by one or more computing devices.

2. The computer-executed method of claim 1, wherein each verb of the at least two verbs within the natural language sentence comprises a verb string having one or more natural language words.

3. The computer-executed method of claim 1, further comprising:
receiving a verb identification input that identifies one or more words of the natural language sentence as a verb;
determining whether the identified one or more words of the natural language sentence is a verb;
in response to determining that the identified one or more words of the natural language sentence is a verb, visually highlighting the one or more words.

4. The computer-executed method of claim 3, further comprising:
receiving a verb tense input, via the graphical user interface, that indicates a particular verb tense for the one or more words;
determining whether the particular verb tense is the correct verb tense for the one or more words;
in response to determining that the particular verb tense is the correct verb tense for the one or more words, visually labeling, within the graphical user interface, the one or more words with a label that indicates the particular verb tense.

5. The computer-executed method of claim 3, further comprising
receiving a second verb identification input that identifies second one or more words of the natural language sentence as a verb;
determining whether the identified second one or more words of the natural language sentence is a verb;
in response to determining that the second one or more words of the natural language sentence is not a verb, displaying, within the graphical user interface, information about the second one or more words.

6. The computer-executed method of claim 1, further comprising:
receiving, via the graphical user interface, error information indicating selection of a particular error status, of a set of error statuses, for the natural language sentence;
wherein the set of error statuses comprises: no verb tense shift, correct verb tense shift, and incorrect verb tense shift.

7. The computer-executed method of claim 6, wherein:
the particular error status indicated in the error information is the error status of incorrect verb tense shift;
a particular verb tense error of the one or more verb tense errors included in the natural language sentence is an error of incorrect verb tense shift; and
the method further comprises:
determining that the particular error status is an accurate error status based on inclusion of the error of incorrect verb tense shift in the one or more verb tense errors for the natural language sentence;
in response to determining that the particular error status is an accurate error status, providing, via the graphical user interface, a mechanism configured to allow the user to indicate selection input that selects a verb within the natural language sentence; and
receiving the selection input that selects the particular verb via the mechanism.

8. A computer-executed method comprising:
displaying a graphical user interface, at a computing device, that depicts two or more natural language sentences;
wherein at least a first natural language sentence of the two or more natural language sentences includes a verb tense error involving a particular verb within the first natural language sentence;
receiving, from a user, information indicating that the first natural language sentence includes a verb tense error;
in response to receiving, from the user, the information indicating that the first natural language sentence includes a verb tense error, providing a control that allows the user to input information for a corrected verb to replace the particular verb in the first natural language sentence;
via the control, receiving input information that represents a particular verb correction;
determining whether the particular verb correction is included in a set of one or more verb corrections for the particular verb in information that is maintained for the first natural language sentence; and
in response to determining that the corrected verb is included in the set of one or more verb corrections for the particular verb, performing one or more of:
communicating successful sentence correction to the user,
recording information indicating successful sentence correction of the first natural language sentence.

9. The computer-executed method of claim 8, wherein at least a second natural language sentence of the two or more natural language sentences does not include a verb tense error.

10. The computer-executed method of claim 8, wherein a second natural language sentence of the two or more natural language sentences includes a second verb tense error involving a certain verb within the second natural language sentence, the method further comprising:
after determining that the corrected verb is included in the set of one or more verb corrections for the particular verb, automatically providing a mechanism that is configured to allow the user to provide information indicating whether the second natural language sentence includes a verb tense error;
receiving, from the user via the mechanism, information indicating that the second natural language sentence includes a verb tense error; and
in response to receiving, from the user, the information indicating that the second natural language sentence includes a verb tense error, providing a second control that allows the user to input information for a second corrected verb to replace the certain verb in the second natural language sentence.

11. One or more non-transitory computer-readable media storing instructions which, when executed by one or more processors, cause performance of:
displaying a graphical user interface that depicts a natural language sentence;
wherein the natural language sentence includes one or more verb tense errors;
wherein the natural language sentence includes at least two verbs;
receiving selection input that selects a particular verb of the at least two verbs within the natural language sentence;
providing a control that allows a user to specify a replacement for the particular verb in the natural language sentence;
receiving input, through the control, that specifies the replacement for the particular verb;
determining whether the replacement is included in a set of one or more verb corrections for the particular verb in information that is maintained for the natural language sentence; and
in response to determining that the replacement is included in the set of one or more verb corrections for the particular verb, performing one or more of:
communicating successful sentence correction to the user, or
recording information indicating successful sentence correction of the natural language sentence.

12. The one or more non-transitory computer-readable media of claim 11, wherein each verb of the at least two verbs within the natural language sentence comprises a verb string having one or more natural language words.

13. The one or more non-transitory computer-readable media of claim 11, further comprising instructions for:
receiving a verb identification input that identifies one or more words of the natural language sentence as a verb;
determining whether the identified one or more words of the natural language sentence is a verb;
in response to determining that the identified one or more words of the natural language sentence is a verb, visually highlighting the one or more words.

14. The one or more non-transitory computer-readable media of claim 13, further comprising instructions for:
receiving a verb tense input, via the graphical user interface, that indicates a particular verb tense for the one or more words;
determining whether the particular verb tense is the correct verb tense for the one or more words;
in response to determining that the particular verb tense is the correct verb tense for the one or more words, visually labeling, within the graphical user interface, the one or more words with a label that indicates the particular verb tense.

15. The one or more non-transitory computer-readable media of claim 13, further comprising instructions for:
receiving a second verb identification input that identifies second one or more words of the natural language sentence as a verb;
determining whether the identified second one or more words of the natural language sentence is a verb;
in response to determining that the second one or more words of the natural language sentence is not a verb, displaying, within the graphical user interface, information about the second one or more words.

16. The one or more non-transitory computer-readable media of claim 11, further comprising instructions for:
receiving, via the graphical user interface, error information indicating selection of a particular error status, of a set of error statuses, for the natural language sentence;
wherein the set of error statuses comprises: no verb tense shift, correct verb tense shift, and incorrect verb tense shift.

17. The one or more non-transitory computer-readable media of claim 16, wherein:
the particular error status indicated in the error information is the error status of incorrect verb tense shift;
a particular verb tense error of the one or more verb tense errors included in the natural language sentence is an error of incorrect verb tense shift; and
the instructions further comprise instructions for:
determining that the particular error status is an accurate error status based on inclusion of the error of incorrect verb tense shift in the one or more verb tense errors for the natural language sentence;
in response to determining that the particular error status is an accurate error status, providing, via the graphical user interface, a mechanism configured to allow the user to indicate selection input that selects a verb within the natural language sentence; and
receiving the selection input that selects the particular verb via the mechanism.

18. One or more non-transitory computer-readable media storing instructions which, when executed by one or more processors, cause performance of:
displaying a graphical user interface, at a computing device, that depicts two or more natural language sentences;
wherein at least a first natural language sentence of the two or more natural language sentences includes a verb tense error involving a particular verb within the first natural language sentence;
receiving, from a user, information indicating that the first natural language sentence includes a verb tense error;
in response to receiving, from the user, the information indicating that the first natural language sentence includes a verb tense error, providing a control that allows the user to input information for a corrected verb to replace the particular verb in the first natural language sentence;
via the control, receiving input information that represents a particular verb correction;
determining whether the particular verb correction is included in a set of one or more verb corrections for the particular verb in information that is maintained for the first natural language sentence; and
in response to determining that the corrected verb is included in the set of one or more verb corrections for the particular verb, performing one or more of:
communicating successful sentence correction to the user,
recording information indicating successful sentence correction of the first natural language sentence.

19. The one or more non-transitory computer-readable media of claim 18, wherein at least a second natural language sentence of the two or more natural language sentences does not include a verb tense error.

20. The one or more non-transitory computer-readable media of claim 18, wherein a second natural language sentence of the two or more natural language sentences includes a second verb tense error involving a certain verb within the second natural language sentence, the instructions further comprising instructions for:
after determining that the corrected verb is included in the set of one or more verb corrections for the particular verb, automatically providing a mechanism that is configured to allow the user to provide information indicating whether the second natural language sentence includes a verb tense error;
receiving, from the user via the mechanism, information indicating that the second natural language sentence includes a verb tense error; and
in response to receiving, from the user, the information indicating that the second natural language sentence includes a verb tense error, providing a second control that allows the user to input information for a second corrected verb to replace the certain verb in the second natural language sentence.
